(19) United States
(12) Patent Application Publication
(10) Pub. No.: US 2025/0286753 A1
(43) Pub. Date: Sep. 11, 2025

(54) TRS BASED DOPPLER ESTIMATION

(71) Applicant: Telefonaktiebolaget LM Ericsson (publ), Stockholm (SE)

(72) Inventors: Per ERNSTRÖM, Stockholm (SE); Shiwei GAO, Nepean (CA); Siva MURUGANATHAN, Stittsville (CA); Jianwei ZHANG, Solna (SE)

(21) Appl. No.: 18/858,843

(22) PCT Filed: Apr. 26, 2023
(86) PCT No.: PCT/IB2023/054323

§ 371 Date: Oct. 22, 2024

Related U.S. Application Data
(60) Provisional application No. 63/336,486, filed on Apr. 29, 2022.

(51) Int. Cl. H04L 25/02; H04L 27/26

(52) U.S. Cl. CPC H04L 25/0222; H04L 25/0228; H04L 27/2646

(57) ABSTRACT

A method, system and apparatus for tracking reference signal (TRS)-based Doppler estimation are disclosed. According to some aspects, a method in a network node includes configuring the WD with an autocorrelation configuration, the autocorrelation configuration including an indication of M different time delays. M being an integer. The method includes receiving from the WD an amplitude of an autocorrelation estimate for a channel between the WD and the network node for each of the M different time delays.

### CROSS-REFERENCE TO RELATED APPLICATION

This application claims priority to U.S. Provisional Application No. 63/336,486, filed Apr. 29, 2022, which is hereby incorporated by reference in its entirety.

### FIELD

The present disclosure relates to wireless communications, and in particular, to tracking reference signal (TRS)-based Doppler estimation.

### BACKGROUND

The Third Generation Partnership Project (3GPP) has developed and is developing standards for Fourth Generation (4G) (or as Long Term Evolution (LTE)) and Fifth Generation (5G) (or New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### MU-MIMO

With multi-user multiple input multiple output (MU-MIMO), two or more users in the same cell are co-scheduled on the same time-frequency resource(s). That is, two or more independent data streams are transmitted to different WDs at the same time, and the spatial domain can typically be used to separate the respective streams. By transmitting several streams simultaneously, the capacity of the system can be increased. This, however, comes at the cost of reducing the signal to interference plus noise ratio (SINR) per stream, as the power is shared between streams and the streams will cause interference to each other.

### Channel State Information Reference Signals (CSI-RS)

For CSI measurement and feedback, CSI-RS are defined. A CSI-RS is transmitted on each antenna port and is used by a WD to measure the downlink (DL) channel between each of the transmit antenna ports and each of its receive antenna ports. The transmit antenna ports are also referred to as CSI-RS ports. The supported number of antenna ports in NR are {1, 2, 4, 8, 12, 16, 24, 32}. By measuring the received CSI-RS, a WD can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain resource elements (REs) in a slot and certain slots. FIG. 1 shows an example of CSI-RS REs for 12 antenna ports, where 1 RE per resource block (RB) per port is shown. See also FIG. 2, which shows an example diagram of time-frequency distribution of symbols.

### TRS

Due to oscillator imperfections, transmission and reception may not be synchronized in time and/or frequency, which can cause inter- and intra-symbol interference. In NR, the tracking reference signal (TRS) was introduced to be used by the WD for synchronization. TRS can be periodic or aperiodic.

From the perspective of 3GPP specifications, a TRS is specified as a special kind of NZP CSI-RS where the corresponding NZP CSI-RS resource set(s) containing a higher layer parameter ‘trs-info’.

A periodic TRS is configured as one or more NZP CSI-RS resource sets each consisting of multiple periodic NZP CSI-RS resources. More specifically, a TRS consists of four one-port, density-3 CSI-RS resources located within two consecutive slots. The CSI-RS resources within each of the NZP CSI-RS resource set(s) can be configured with a periodicity of 10, 20, 40, or 80 ms. Note that the exact set of REs used for the TRS may vary. There is always a four-symbol time-domain separation between the two CSI-RS resources within a slot. FIG. 2 shows an example of a TRS burst of 2 TRS symbols per slot in 2 adjacent slots. NR also supports aperiodic TRS.

### Csi Framework in NR

In NR, a WD can be configured with multiple CSI reporting settings and multiple CSI-RS resource settings. Each resource setting can contain multiple resource sets, and each resource set can contain up to 8 CSI-RS resources. For each CSI reporting setting, a WD feeds back a CSI report.

Each CSI reporting setting contains one or more of the following information:
A CSI-RS resource set for channel measurement;
A resource set for interference measurement;
Optionally, a CSI-RS resource set for interference measurement;
Time-domain behavior, i.e., periodic, semi-persistent, or aperiodic reporting;
Frequency granularity, i.e., wideband or subband;
Report quantity which indicates the CSI parameters to be reported such as rank indicator (RI), precoder matrix indicator (PMI), channel quality indicator (CQI), and CSI-RS resource indicator (CRI) in case of multiple CSI-RS resources in a CSI-RS resource set;
Codebook types, i.e., Type I or II, and codebook subset restriction;
Measurement restriction; and
CQI Subband size.
   Type 1 and type 2 codebooks in NR

Type 1 codebook (CB) is typically used by a WD to report CSI for single user MIMO (SU-MIMO) scheduling in NR. A type 2 CB is typically for more accurate CSI feedback for multi-user MIMO (MU-MIMO) scheduling.

In case of type 1 CB, the precoding vector for each MIMO layer is associated with a single DFT beam. While for type 2 CB, the precoding vector for each layer is a linear combination of multiple DFT beams.

### Enhanced Type 2 Codebook in NR

In NR 3GPP Technical Release 16 (3GPP Rel-16), the type 2 CB is enhanced by applying frequency domain (FD) DFT basis across all subbands to reduced CSI feedback overhead and/or improve CSI accuracy.

### QCL

Several signals can be transmitted from different antenna ports of a same base station. These signals can have the same large-scale properties such as Doppler shift/spread, average delay spread, or average delay. These antenna ports are then said to be quasi co-located (QCL).

If the WD knows that two antenna ports are QCL with respect to a certain parameter (e.g., Doppler spread), the WD can estimate that parameter based on one of the antenna ports and apply that estimate for receiving signal on the other antenna port. Typically, the first antenna port is represented by a measurement reference signal such as TRS or synchronization signal block (SSB) (known as the source RS) and the second antenna port is a demodulation reference signal (DMRS) (known as the target RS).

For instance, if antenna ports A and B are QCL with respect to average delay, the WD can estimate the average delay from the signal received from antenna port A and assume that the signal received from antenna port B has the same average delay. This is useful for demodulation since the WD can know beforehand the properties of the channel, which for instance helps the WD in selecting an appropriate channel estimation filter.

Information about what assumptions can be made regarding QCL is signaled to the WD from the network. In NR, four types of QCL relations between a transmitted source RS and transmitted target RS were defined:
Type A: {Doppler shift, Doppler spread, average delay, delay spread};
Type B: {Doppler shift, Doppler spread};
Type C: {average delay, Doppler shift}; and
Type D: {Spatial Rx parameter}.

### Multi-TRP Transmission

Reliable physical downlink shared channel (PDSCH) and physical downlink control channel (PDCCH) transmission with multiple transmission points (TRP) has been introduced respectively in NR 3GPP Rel-16 and 3GPP Rel-17, in which a PDSCH or PDCCH may be transmitted over multiple TRPs to improve reliability. An example is shown in FIG. 3, where TRP specific TRS and CSI-RS are transmitted from each TRP while PDSCH and PDCCH may be repeated over different TRPs.

It is observed by measurements in real deployments that downlink MU-MIMO precoding performance degrades when one or more of the co-scheduled WDs start to move faster than a few km/h. The reason is that the information of the channels, used to compute the precoding, becomes outdated rather soon when this occurs.

Thus, making downlink MU-MIMO precoding robust at higher WD speeds is a problem. It has been considered in 3GPP Rel-18 scoping, to extend Type-II CSI feedback with time domain/Doppler information. The problem with this approach is that Type-II CSI computation is already highly complex in current 3GPP releases, including measurements of up to 32 CSI-RS ports. Adding time domain information extraction on top of this makes the complexity for the WD even higher.

Another problem is that Type-II feedback does not extend to multi-transmission and reception point (TRP) operation and L1/L2 mobility, since it is introduced with a single TRP based operation in mind. It is also a problem how to make MU-MIMO precoding across multiple TRPs more robust to WD speed while at the same time maintaining low WD complexity.

### SUMMARY

Some embodiments advantageously provide methods, network nodes and wireless devices for TRS-based Doppler estimation.

In some embodiments, the WD is configured to perform, performs and reports, Doppler related measurements based on the TRS (also referred to as the CSI-RS for tracking). In some embodiments, the network node utilizes these measurements to switch between different modes of operation such as, e.g.,:
Sounding reference signal (SRS) based reciprocity mode vs. CSI feedback based mode;
No additional DMRS symbols vs. one additional DMRS symbol; and/or
Two additional DMRS symbols vs. Three additional DMRS symbols. Some embodiments may include:
Doppler related measurement quantity definitions;
Methods for measurement configuration;
Estimation methods;
Methods for measurement reporting; and/or
Methods for utilizing Doppler related measurements for the network node to decide on performing certain actions such as switching between two modes.

Some embodiments may include WD measurements of the autocorrelation for multiple delays, and the corresponding measurement configuration and measurement reporting details.

Some embodiments include WD measurements of the autocorrelation across TRS bursts, i.e., for delays corresponding to the TRS period or a multiple of TRS periods, and methods to compensate for phase incoherency and/or OFDM window adjustments, and the corresponding measurement configuration and measurement reporting details.

Some embodiments include WD measurements of the relative frequency offset and power per identified peak in the channel impulse response and the corresponding measurement configuration and measurement reporting details.

Some embodiments include methods to estimate the Doppler spread based on the autocorrelation for multiple delays.

Some embodiments include methods to estimate various Doppler quantities based on estimates of the relative frequency offset and power per identified peak in the channel impulse response.

According to one aspect, a method in a wireless device, WD, configured to communicate with a network node is provided. The method includes determining an autocorrelation estimate for a channel between the WD and the network node for each of M time delays, M being an integer. The method also includes reporting to the network node an indication of an amplitude of each of the autocorrelation estimates for the M time delays.

According to another aspect, a WD includes processing circuitry and a radio interface that configure the WD to perform any of the methods described above.

According to yet another aspect, a method in a network node configured to communicate with a wireless device WD is provided. The method includes configuring the WD with an autocorrelation report configuration, the autocorrelation report configuration including an indication of M time delays, M being an integer. The method also includes receiving from the WD an amplitude of an indication of an autocorrelation estimate for a channel between the WD and the network node for each of the M time delays.

According to another aspect, a network includes processing circuitry and a radio interface that configure the network node to perform any of the methods described above.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of resource elements;

FIG. 2 illustrates TRS periodicity;

FIG. 3 illustrates multiple TRPs;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node for tracking reference signal (TRS)-based Doppler estimation;

FIG. 11 is a flowchart of an example process in a wireless device for tracking reference signal (TRS)-based Doppler estimation;

FIG. 12 is a flowchart of an example process in a network node for tracking reference signal (TRS)-based Doppler estimation;

FIG. 13 is a flowchart of an example process in a wireless device for tracking reference signal (TRS)-based Doppler estimation;

FIG. 14 illustrates an example of TRS timing;

FIG. 15 illustrates an example of TRS burst periodicity;

FIG. 16 illustrates another example of TRS burst periodicity;

FIG. 17 illustrates a Bessel function;

FIG. 18 illustrates one example of a power spectral density function;

FIG. 19 is a flowchart of one example process in a WD according to principles set forth herein; and

FIG. 20 is a flowchart of one example process in a network node according to principles set forth herein.

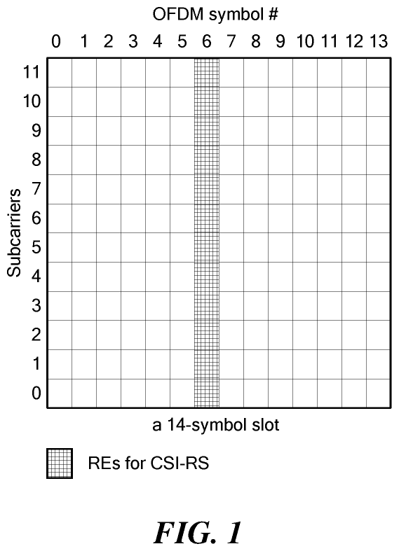

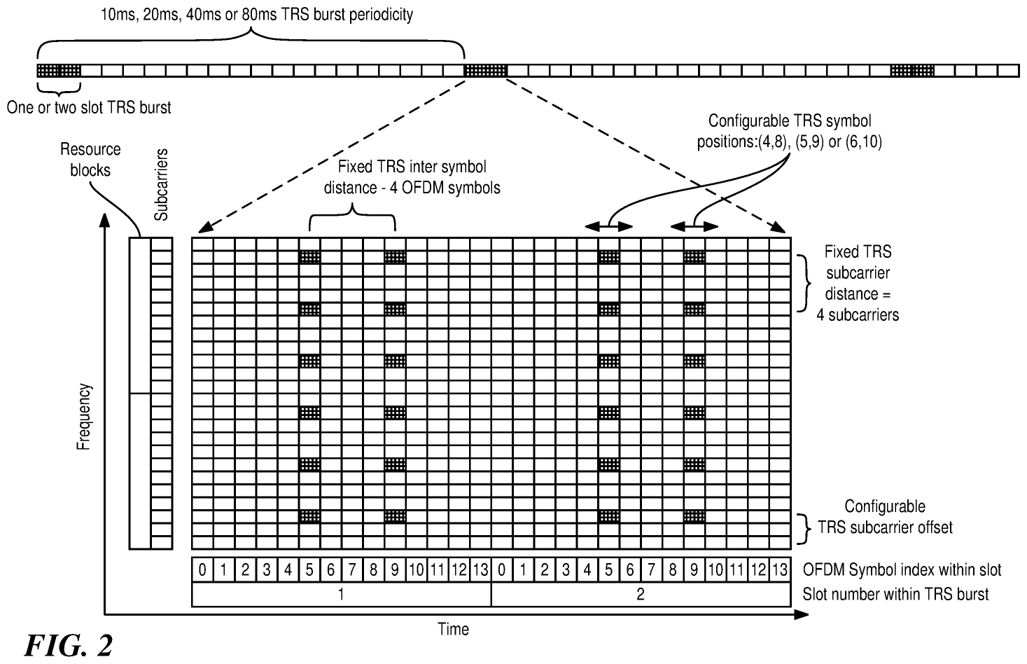

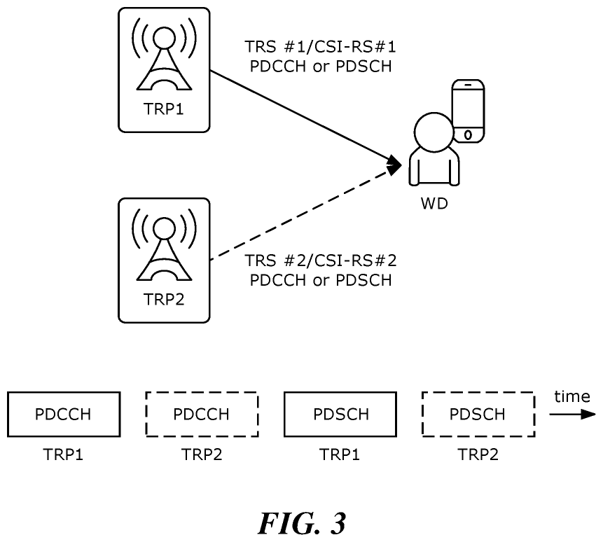

### DETAILED DESCRIPTION

Before describing in detail example embodiments, it is noted that the embodiments reside primarily in combinations of apparatus components and processing steps related to TRS-based Doppler estimation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

The term “network node” used herein can be any kind of network node comprised in a radio network which may further comprise any of base station (BS), radio base station, base transceiver station (BTS), base station controller (BSC), radio network controller (RNC), g Node B (gNB), evolved N B (eNB), NB, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) or a radio network node.

In some embodiments, the non-limiting terms WD or a user equipment (UE) are used interchangeably. The WD herein can be any type of wireless device capable of communicating with a network node or another WD over radio signals. The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, eNB, NB, gNB, MCE, IAB node, relay node, access point, radio access point, RRU and RRH.

Note that although terminology from one particular wireless system, such as, for example, 3GPP LTE and/or NR, may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide tracking reference signal (TRS)-based Doppler estimation. Measurements of the autocorrelation for multiple delays allows for better accuracy in Doppler spread estimates as well as for avoiding ambiguities in Doppler spread estimation.

Measurements of the autocorrelation for multiple delays gives information on the variability of the radio channel over different timescales which allows the network node to take better decisions, e.g. on switching between different modes such as CSI feedback mode and reciprocity mode, or to decide on a suitable number of additional DMRS symbols,

Measurements of the autocorrelation at large delays, e.g. across TRS bursts, give information on the variability of the channel over longer timescales. This can be crucial when using the autocorrelation to taking decisions of mode switching/selection such as e.g. CSI-feedback mode or reciprocity mode or in the selecting the number of additional DMRS symbols to use.

Measurements across TRS bursts of Doppler shifts, frequency offsets, Doppler spread, and Doppler power spectra can give better accuracy for these measurement. This can be crucial when using the autocorrelation to taking decisions of mode switching/selection such as e.g. CSI-feedback mode or reciprocity mode or in the selecting the number of additional DMRS symbols to use.

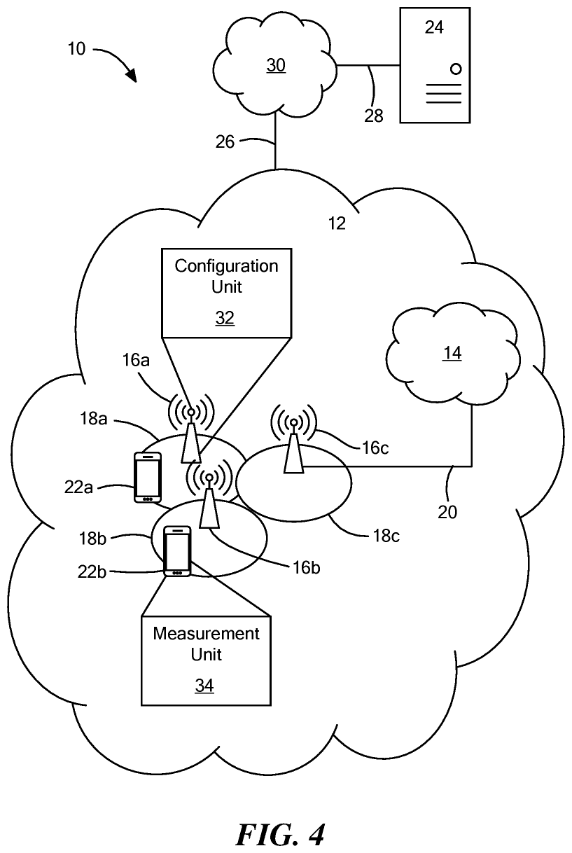

Returning now to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first WD 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which may be configured to select a mode of operation based at least in part on the received Doppler-related measurements, the mode of operation relating to at least one of a feedback mode and a number of demodulation reference signals, DMRS. The configuration unit 32 may be configured to configure the WD 22 with an autocorrelation configuration, the autocorrelation configuration including an indication of M time delays, M being an integer.

A wireless device 22 is configured to include a measurement unit 34 which may be configured to perform Doppler-related measurements on the TRS according to the configuration received from the network node 16. The measurement unit 34 may be configured to determine an autocorrelation estimate for a channel between the WD 22 and the network node 16 for each of M time delays, M being an integer.

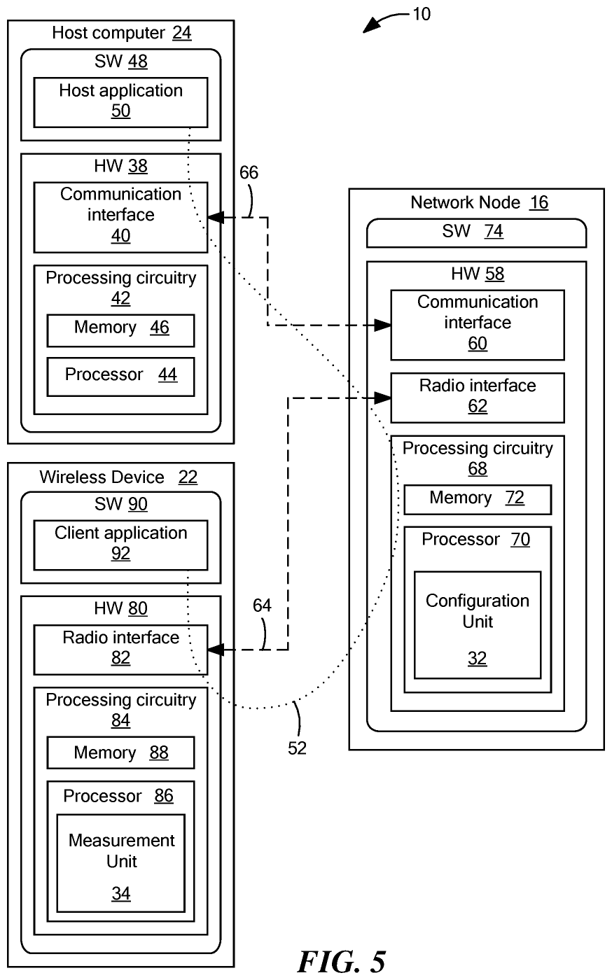

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable ROM).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs and/or ASICs adapted to execute instructions. The processor 70 may be configured to access (e.g., write to and/or read from) the memory 72, which may comprise any kind of volatile and/or nonvolatile memory, e.g., cache and/or buffer memory and/or RAM and/or ROM and/or optical memory and/or EPROM.

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which may be configured to select a mode of operation based at least in part on the received Doppler-related measurements, the mode of operation relating to at least one of a feedback mode and a number of demodulation reference signals, DMRS. The configuration unit 32 may be configured to configure the WD 22 with an autocorrelation configuration, the autocorrelation configuration including an indication of M time delays, M being an integer.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. The processor 86 and memory 88 may be similar as the processor 68 and memory 72 as described above.

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a measurement unit 34 which may be configured to perform Doppler-related measurements on the TRS according to the configuration received from the network node 16. The measurement unit 34 may be configured to determine an autocorrelation estimate for a channel between the WD 22 and the network node 16 for each of M time delays, M being an integer.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results.

The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

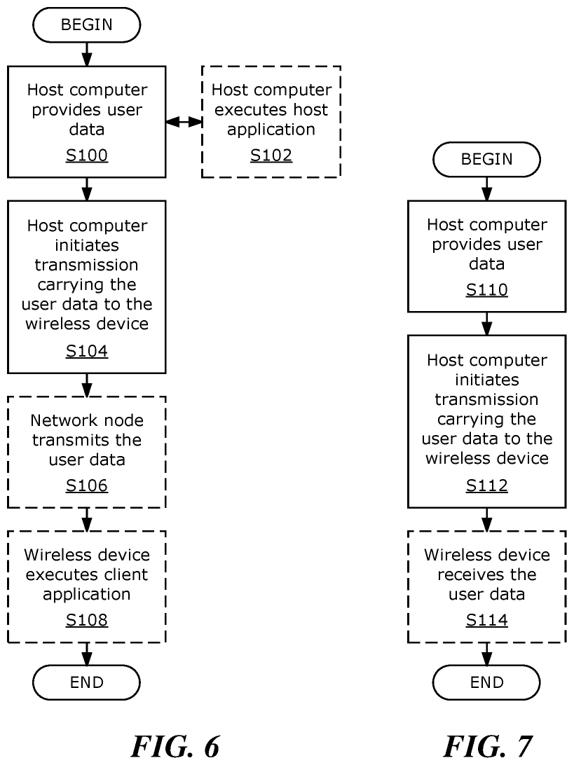

Although FIGS. 5 and 6 show various “units” such as configuration unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

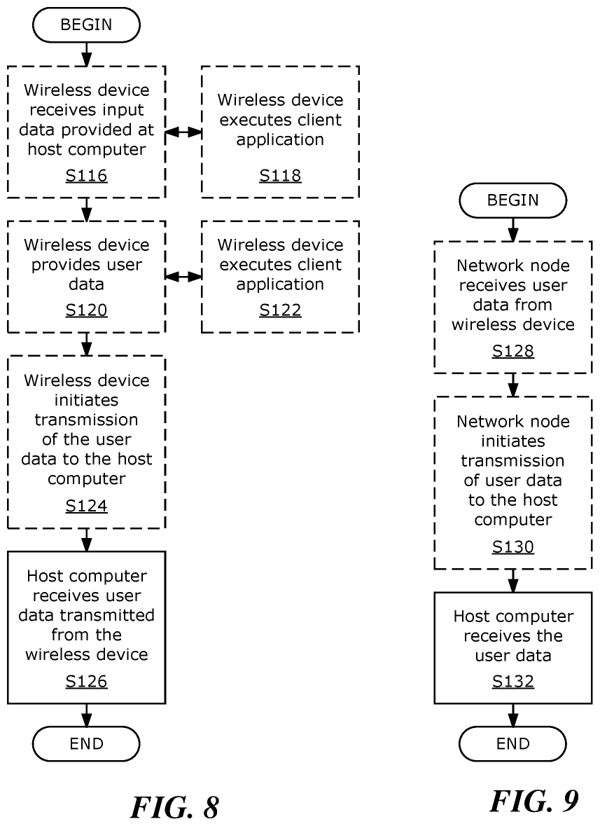

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

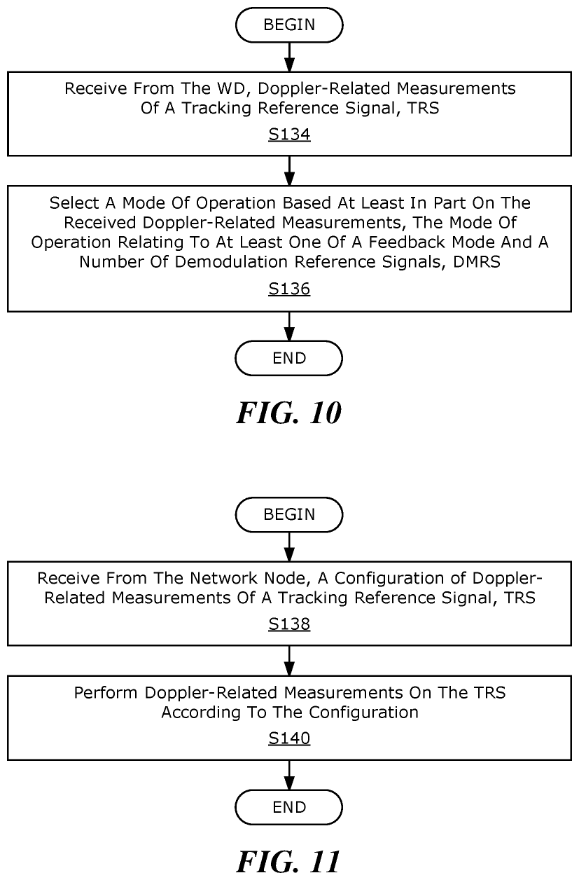

FIG. 10 is a flowchart of an example process in a network node 16 for tracking reference signal (TRS)-based Doppler estimation. Network node 16 such as via processing circuitry 68 and/or processor 70 and/or radio interface 62 and/or communication interface 60 is configured to receive from the WD, Doppler-related measurements of a TRS (Block S134). The process also includes selecting a mode of operation based at least in part on the received Doppler-related measurements, the mode of operation relating to at least one of a feedback mode and a number of demodulation reference signals, DMRS (Block S136).

In some embodiments, the Doppler-related measurements from the WD are postprocessed by at least one of the WD and the network node before selecting the mode of operation. In some embodiments, a feedback mode comprises one of a CSI feedback mode and a reciprocity mode. In some embodiments, the Doppler-related measurements include measurement of at least one of Doppler shift, frequency offset, Doppler spread and Doppler power spectra. In some embodiments, the Doppler-related measurements are based at least in part on an autocorrelation of a channel estimate.

FIG. 11 is a flowchart of an example process in a WD 22 according to some embodiments. Wireless device 22 such as via processing circuitry 84 and/or processor 86 and/or radio interface 82 is configured to receive from the network node, a configuration of Doppler-related measurements of a TRS (Block S138). The process also includes performing Doppler-related measurements on the TRS according to the configuration (Block S140).

In some embodiments, the configuration of Doppler-related measurements are based at least in part on a mode of operation of the network node, the mode of operation relating to at least one of a feedback mode and a number of DMRS. In some embodiments, the Doppler-related measurements include measurement of at least one of Doppler shift, frequency offset, Doppler spread and Doppler power spectra. In some embodiments, the Doppler-related measurements are based at least in part on an autocorrelation of a channel estimate.

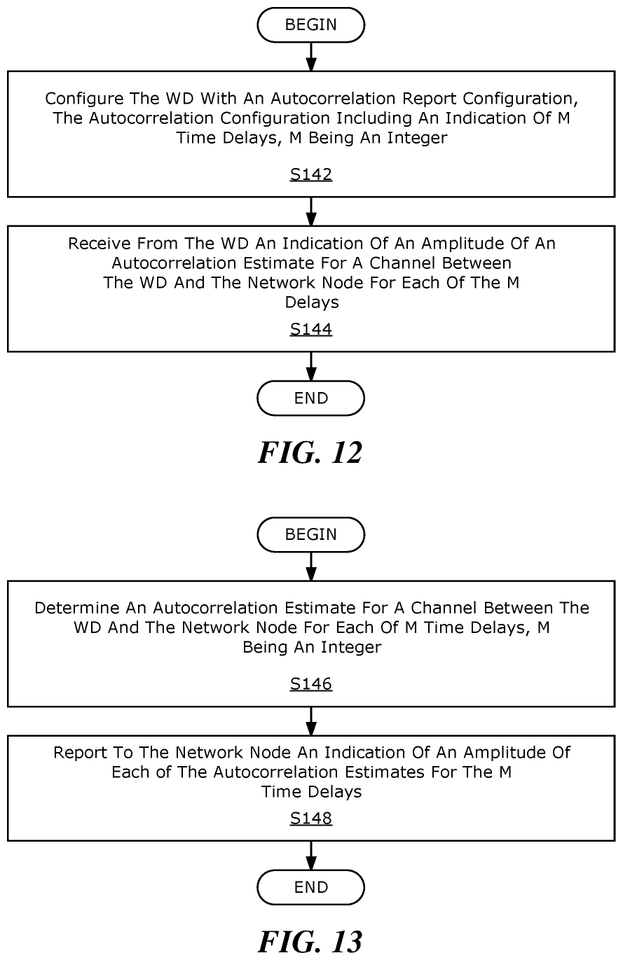

FIG. 12 is a flowchart of an example process in a network node 16 for tracking reference signal (TRS)-based Doppler estimation. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure the WD 22 with an autocorrelation report configuration, the autocorrelation report configuration including an indication of M time delays, M being an integer (Block S142). The method also includes receiving from the WD 22 an indication of an amplitude of an autocorrelation estimate for a channel between the WD 22 and the network node 16 for each of the M time delays (Block S144).

In some embodiments, the M time delays are selected from a group of N configured time delays, N being an integer greater than or equal to M. In some embodiments, the N configured time delays are preconfigured in the WD 22. In some embodiments, the method includes transmitting to the WD 22 an indication of the N configured time delays. In some embodiments, the method includes receiving from the WD 22 a phase of an autocorrelation estimate for each of the M time delays. In some embodiments, the autocorrelation report configuration includes at least one periodic tracking signal, TRS, for channel measurement and the autocorrelation estimate.

FIG. 13 is a flowchart of an example process in a wireless device 22 according to some embodiments of the present disclosure. One or more blocks described herein may be performed by one or more elements of wireless device 22 such as by one or more of processing circuitry 84 (including the measurement unit 34), processor 86, radio interface 82 and/or communication interface 60. Wireless device 22 such as via processing circuitry 84 and/or processor 86 and/or radio interface 82 is configured to determine an autocorrelation estimate for a channel between the WD 22 and the network node 16 for each of M time delays, M being an integer (Block S146). The method also includes reporting to the network node 16 an indication of an amplitude of each of the autocorrelation estimates for the M time delays (Block S148).

In some embodiments, the M time delays are selected from a group of N configured time delays, N being an integer greater than or equal to M. In some embodiments, the N configured time delays are preconfigured in the WD 22. In some embodiments, the method also includes receiving from the network node 16 an indication of the N configured time delays. In some embodiments, the method also includes receiving from the network node 16 an indication of the M time delays. In some embodiments, the autocorrelation estimate for the channel for a time delay is determined based at least in part on channel estimates at least at two time instances of the multiple time instances, wherein the two time instances are separated by a time duration equal to the time delay. In some embodiments, each of the M time delays is given in terms of one of a number of symbols and a number of slots in time. In some embodiments, the method also includes reporting to the network node 16 a phase of the autocorrelation estimates for each of the M time different delays. In some embodiments, the method includes estimating the channel at multiple time instances based at least in part on at least one reference signal, wherein the multiple time instances are associated to the M time delays. In some embodiments, each of the at least one reference signal is a tracking reference signal, TRS. In some embodiments, at least one of the at least one reference signals is a periodic TRS being transmitted periodically in one of a time slot and two consecutive time slots. In some embodiments, at least one of the at least one reference signal is an aperiodic TRS being transmitted in one of a time slot and two consecutive time slots. In some embodiments, the method includes determining the autocorrelation estimate for each of the M time delays based on channel estimates at the multiple time instances. In some embodiments, each of the M amplitudes is a normalized amplitude. In some embodiments, the method includes quantizing the amplitude and the phase of the autocorrelation estimates for each of the M time delays. In some embodiments, the autocorrelation estimates are determined for each of the M time delays based at least in part on at least one a channel state information reference signal, CSI-RS, and a demodulation reference signal, DMRS, separated in time. In some embodiments, reporting to the network node 16 an indication of the autocorrelation estimates is one of periodic, semi-persistent and aperiodic. In some embodiments, the method includes receiving a configuration of the at least one reference signal and a channel state information, CSI, report for reporting the autocorrelation estimates for the M time delays based on the at least one reference signal.

Having described the general process flow of arrangements of the disclosure and having provided examples of hardware and software arrangements for implementing the processes and functions of the disclosure, the sections below provide details and examples of arrangements for TRS-based Doppler estimation.

### Autocorrelation Based Methods

### Estimation of the Autocorrelation

The auto-correlation function of a stochastic channel h_{i,j}(t) is defined as:

$${R}_{i , j} ( t , τ ) = E [ {h}_{i , j} ( t ) {h}_{i , j}^{*} ( t - τ ) ] ,$$

where h_{i,j}(t) is the channel between the i^{th} transmit (Tx antenna port at the network node 16 and the j^{th} Rx antenna port at the WD 22 at time t; τ is the time delay; and (·)* denote complex conjugate. For TRS, a single port is used, i.e., the index i takes only one value and can thus be omitted.

Consider R_{i,j}(t, τ) as roughly independent of t over time intervals smaller than some value Δt as long as τ<<Δt. The delay τ captures the fast fading of the channel while t captures more long-term changes of the channel, e.g., depending on a change in WD 22 velocity or the movement of the WD 22 into an area with different multi-path characteristics. One may note that for a wide sense stationary stochastic process there is no time dependence in the auto-correlation function.

The normalized auto-correlation function is defined as:

$${ρ}_{i , j} ( t , τ ) = \frac{{R}_{i , j} ( t , τ )}{{R}_{t , j} ( t , 0 )}$$

The auto-correlation function of the channel seen as a continuous time signal (rather than as a stochastic process) on the other hand may be defined as:

$${Q}_{i , j} ( τ ) = {lim}_{T \to ∞} \frac{1}{2 T} {\int }_{- T}^{+ T} {h}_{i , j} ( t ) {h}_{i , j}^{*} ( t - τ ) dt$$

which may also be normalized as:

$${q}_{i , j} ( τ ) = \frac{{Q}_{i , j} ( τ )}{{Q}_{t , j} ( 0 )}$$

Define a time dependent autocorrelation function:

$${Q}_{i , j}^{Δ r} ( t , τ ) = \frac{1}{Δ t - τ} {\int }_{t - Δ t + τ}^{t} {h}_{i , j} ( t ) {h}_{i , j}^{*} ( t - τ ) dt$$

$${q}_{i , j}^{Δ t} ( t , τ ) = \frac{{Q}_{i , j}^{Δ t} ( t , τ )}{{Q}_{i , j}^{Δ t} ( t , 0 )}$$

This may be viewed as an estimate of ρ_{i,j}(t, τ), and, for a slowly varying ρ_{i,j}(t, τ), can also be used some time into the future, i.e., as an estimate of ρ_{i,j}(t′, τ), with t′>t.

Clearly, the WD 22 doesn't have full knowledge of the channel in continuous time but rather only has some knowledge of the channel at certain discrete time occasions for which there are reference signals (i.e., the TRS) available for channel estimation.

In some embodiments, the WD 22 estimates q_{i,j}^{Δt}(t, τ) and Q_{i,j}^{Δt}(t, τ) for a number of t values for which pairs of reference signals exist with a distance in time given by τ.

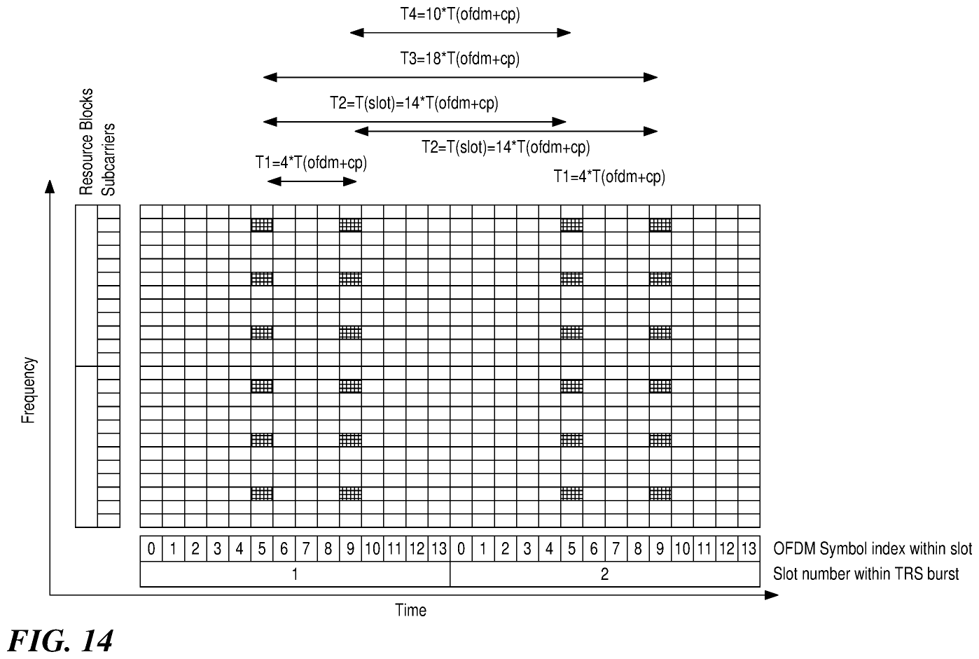

FIG. 14 shows a graph/table of example delays τₖ for which the autocorrelation can be estimated based on intra TRS burst measurements using the TRS signal. Note that for τ₁=4. T_{OFDM+CP} and for 12=T_{SLOT}=14·T_{OFDM+CP} there are two samples within the TRS burst that can be used for the measurement, while for τ₃=18·T_{OFDM+CP} and τ₄=10·T_{OFDM+CP} there is only one sample within the TRS burst that can be used for the measurement.

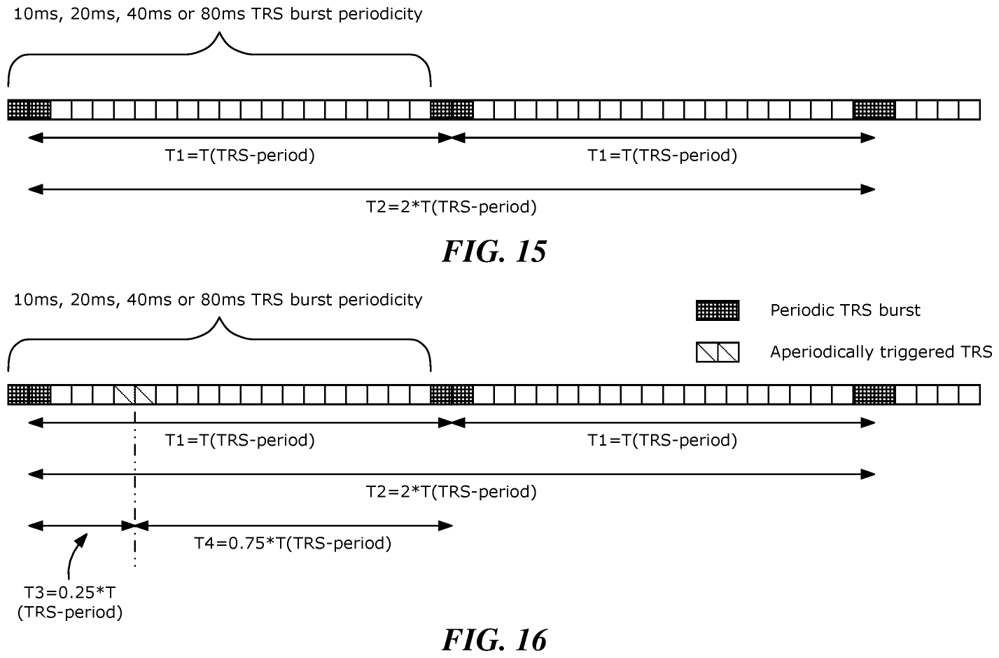

FIG. 15 shows a graph/chart of example delays τₖ=k·T_{TRS-period} for which the autocorrelation can be estimated based on inter TRS burst measurements using the TRS signal. Note that for each pair of TRS bursts used, four samples can be used since each burst may consist of four TRS symbols.

In some embodiments, the WD 22 estimates q_{i,j}^{Δt}(t, τ) and Q_{i,j}^{Δt}(t, τ) for a number of τ values for which the pairs of reference signals with a distance in time of τ where a pair of reference signals may comprise one periodic TRS and one aperiodically triggered TRS (referred to as aperiodic TRS, henceforth), as shown in FIG. 16. In this case, the aperiodically triggered TRS is configured to be QCLed with the periodic TRS with respective to QCL Type A and/or QCL Type D, where applicable (i.e., each pair of periodic TRS and aperiodic TRS used to estimate q_{i,j}^{Δt}(t, τ) and Q_{i,j}^{Δt}(t, τ) are QCLed). Note that the aperiodic TRS may also be part of an aperiodic TRS burst containing one or more aperiodic TRSs. In some embodiments, the number of TRS resources and the number of slots over which the TRSs are located (i.e., over one or two slots) is the same between the periodic TRS burst and the aperiodic TRS burst. As shown in M 17, the t value for a q_{i,j}^{Δt}(t, τ) and Q_{i,j}^{Δt}(t, τ) estimate using a periodic TRS and aperiodic TRS depends on which slot the aperiodic TRS is triggered. In the example of FIG. 16, the aperiodic TRS is triggered 0.25T_{TRS-period} slots later than the first periodic TRS burst shown in FIG. 16. Hence, using the first periodic TRS burst and the aperiodic TRS burst, q_{i,j}^{Δt}(t, τ) and Q_{i,j}^{Δt}(t, τ) can be estimated for a τ value of 0.25T_{TRS-period}. The time distance between the second periodic TRS burst shown in FIG. 16 and the aperiodic TRS burst is 0.75T_{TRS-period}. Using the second periodic TRS burst and the aperiodic TRS burst, q_{i,j}^{Δt}(t, τ) and Q_{i,j}^{Δt}(t, τ) can be estimated for a τ value of 0.75T_{TRS-period}.

In some embodiments, the WD 22 estimates the integrals over time in q_{i,j}^{Δt}(t, τ) and Q_{i,j}^{Δt}(t, τ) as discrete sums over time occasions.

Referring to an estimate as ϕ^{Δt}(t, τ), some example embodiments for how to perform such an estimate are described below.

Let Xₗ[n], n=0 . . . N−1 be the received frequency domain reference signal samples after matched filtering. Index l denotes the different OFDM symbols carrying the reference symbols used for the correlation estimation. The starting point in time of the OFDM symbol l is given by tₗ (to be precise tₗ denotes the start of the non-cyclic prefix (CP) part of the OFDM symbol). Index n denotes a reference signal sample index (assumed to be proportional to subcarrier index). In some embodiments, it is assumed that the reference signal used is on a regular comb.

Let Pₘ(n), m=1 . . . M, n=1,2 be the l-indices of M symbol pairs to use for the estimation of the autocorrelation for a delay τ=t_{P}_{ₘ}₍₂₎−t_{P}_{ₘ}₍₁₎. Assume that all symbol pairs are separated by the same distance in time (small differences due to the existence of two different cyclic prefix (CP) lengths can typically be safely neglected and thus it is sufficient that the symbol pairs are separated by the same inter symbol distance counted in number of OFDM symbols).

In some embodiments, a low-complexity estimate of the normalized autocorrelation for a delay τ is calculated in the frequency domain as:

$${ϕ}^{Δ t} ( t , τ ) = \frac{{\sum }_{m = 1}^{M} {\sum }_{n = 0}^{N - 1} {X}_{{P}_{m} ( 2 )} [ n ] \cdot {X}_{{P}_{m} ( 1 )}^{*} [ n ]}{\frac{1}{2} \cdot {\sum }_{m = 1}^{M} {\sum }_{n = 0}^{N - 1} ( {X}_{{P}_{m} ( 1 )} [ n ] \cdot {X}_{{P}_{m} ( 1 )}^{*} [ n ] + {X}_{{P}_{m} ( 2 )} [ n ] \cdot {X}_{{P}_{m} ( 2 )}^{*} [ n ] )} ,$$

In some embodiments, the inverse DFT is calculated for each OFDM symbol l: Yₗ[k]=ifft(Xₗ[n])

The estimate of the normalized autocorrelation over time interval Δt may be calculated as:

$${ϕ}^{Δ t} ( t , τ ) = \frac{{\sum }_{m = 1}^{M} {\sum }_{k ∈ Γ ( m )} {X}_{{P}_{m} ( 2 )} [ k ] \cdot {Y}_{{P}_{m} ( 1 )}^{*} [ k ]}{\frac{1}{2} \cdot {\sum }_{m = 1}^{M} {\sum }_{k ∈ Γ ( m )} ( {Y}_{{P}_{m} ( 1 )} [ k ] \cdot {Y}_{{P}_{m} ( 1 )}^{*} [ k ] + {Y}_{{P}_{m} ( 2 )} [ k ] \cdot {Y}_{{P}_{m} ( 2 )}^{*} [ k ] )} ,$$

where the sum over time samples is over sets Γ(m) defined to suppress noise, e.g. by using a noise threshold such as, e.g.:

$$k ∈ Γ ( m ) ⇔ \{ \begin{matrix}\frac{\vert {Y}_{{P}_{m} ( 1 )} [ k ] \vert}{{σ}_{{P}_{m} ( 1 )}} > threshold \\ \frac{\vert {Y}_{{P}_{m} ( 2 )} [ k ] \vert}{{σ}_{{P}_{m} ( 2 )}} > threshold\end{matrix}$$

where σ_{P}_{ₘ}₍ᵢ₎ are noise estimates. Alternatively, Γ(m) may be an interval separating the channel from noise based on an Akaike criteria.

The measurement period for ϕ^{Δt}(t_{b}, τ) may be defined as the interval
[tₐ,t_{b}]
where

$${t}_{a} = {min}_{m} {t}_{{P}_{m} ( 1 )}$$

$${t}_{b} = {max}_{m} {t}_{{P}_{m} ( 2 )}$$

$$Δ t = {t}_{a} - {t}_{b} = {max}_{m} {t}_{{P}_{m} ( 2 )} - {min}_{m} {t}_{{P}_{m} ( 1 )}$$

In some embodiments, the WD 22 measures and reports individual measurement of ϕ^{Δt}(t, τ).

In some embodiments, the WD 22 performs multiple measurements ϕ^{Δt}(tᵢ, τ) within a longer measurement period [Tₐ, T_{b}], and reports ϕ^{Δt} filtered and/or averaged over the multiple measurements within the longer measurement period.

The normalized autocorrelation function ρ_{i,j}(t, τ) is the inverse Fourier transform of the Doppler spectrum. It is real valued and takes values between −1 and 1. The estimate ϕ^{Δt}(t, τ) may, however, be complex due to a offset in the frequency used for down-spreading by the WD 22 and also due to the limited amount of averaging over time.

In some embodiments, the complex valued estimate ϕ^{Δt}(t, τ) is reported.

In some embodiments, the absolute value |ϕ^{Δt}(t, τ)| is reported.

In some embodiments, |ϕ^{Δt}(t, τ)|·sgn(Re(ϕ^{Δt}(t, τ))) is reported.

In some embodiments, the WD 22 uses the estimated autocorrelation to estimate the Doppler spread of the channel and reports the estimated Doppler spread.

### Estimation of the Autocorrelation Across Different TRS Bursts

If the autocorrelation delay τ is large, e.g., if the estimation is done across two different TRS bursts τ being equal to the TRS burst period or to a multiple of the TRS burst period (or an integer multiple of the slot time if the estimation is done between a periodic TRS burst and an aperiodic TRS burst or between two aperiodic TRS bursts), then the WD 22 may have adjusted the OFDM window between the reception of the first and second TRS symbol used in the measurement. This results in a cyclic shift Δk of the channel impulse response in delay. In addition, phase coherency may be lost, resulting in an overall phase difference between measurements performed at the two occasions in time.

Methods to estimate the cyclic shift Δk of the channel impulse response are given, herein.

In some embodiments, the WD 22 compensates for an OFDM adjustment through a circular shift with a number Δk samples and/or for phase incoherency through a complex phase φ, estimating the autocorrelation in the time domain e.g. as

$${ϕ}^{Δ t} ( T , τ ) = \frac{{\sum }_{m = 1}^{M} {\sum }_{k ∈ Γ ( m )} {Y}_{{P}_{m} ( 2 )} [ ( k + Δk ) mod N ] \cdot {e}^{- i φ} \cdot {Y}_{{P}_{m} ( 1 )}^{*} [ k ]}{\begin{matrix}\frac{1}{2} \cdot {\sum }_{m = 1}^{M} {\sum }_{k ∈ Γ ( m )} ( {Y}_{{P}_{m} ( 1 )} [ k ] \cdot {Y}_{{P}_{m} ( 1 )}^{*} [ k ] + {Y}_{{P}_{m} ( 2 )} [ ( k + Δ k ) mod N ] \cdot \\ {Y}_{{P}_{m} ( 2 )}^{*} [ ( k + Δ k ) mod N ] )\end{matrix}} ,$$

In some embodiments, the WD 22 compensates for an OFDM adjustment through a frequency dependent phase rotation

$${e}^{- i \frac{2 π}{N} Δ k \cdot n}$$

and/or for phase incoherency through an overall phase factor e^{iφ}, estimating the autocorrelation in the frequency domain, e.g., as:

$${ϕ}^{Δ t} ( t , τ ) = \frac{{\sum }_{m = 1}^{M} {\sum }_{n = 0}^{N - 1} {X}_{{P}_{m} ( 2 )} [ n ] \cdot {e}^{- i \frac{2 π}{N} Δ k \cdot n} \cdot {e}^{- i φ} \cdot {X}_{{P}_{m} ( 1 )}^{*} [ n ]}{\frac{1}{2} \cdot {\sum }_{m = 1}^{M} {\sum }_{n = 0}^{N - 1} ( {X}_{{P}_{m} ( 1 )} [ n ] \cdot {X}_{{P}_{m} ( 1 )}^{*} [ n ] + {X}_{{P}_{m} ( 2 )} [ n ] \cdot {X}_{{P}_{m} ( 2 )}^{*} [ n ] )}$$

In some embodiments, the OFDM window offset Δk samples, is estimated by finding the offset Δk which gives the best match between the impulse response at the two time occasions. In some embodiments, the best match is defined as the match that gives the highest number of matching peaks.

In some embodiments, the phase σ is the estimated phase difference of the channel impulse response at the delay k′ strongest peak, e.g., as:

$$φ = arg ( {\sum }_{m = 1}^{M} {Y}_{{P}_{m} ( 2 )} [ ( {k}^{′} + Δ k ) mod N ] \cdot {Y}_{{P}_{m} ( 1 )}^{*} [ {k}^{′} ] )$$

In some embodiments, no compensation is performed for phase incoherency, i.e., φ=0.

Note that in the formulas above, it is assumed that there is no phase incoherency or OFDM window change between OFDM symbols Pₘ(1), m=1 . . . M. Similarly, it is assumed that there is no phase incoherency or OFDM window change between OFDM symbols Pₘ(2), m=1 . . . M. Phase incoherency or OFDM window change may be assumed to occur between OFDM symbols Pₘ(1) and P_{m′}(2), This may typically be the case when OFDM symbols Pₘ(1), m=1 . . . M are all within one and the same TRS burst, while P_{m′}(2), m=1 . . . M′ are all within another TRS burst. Generally, φ and Δk can be allowed to depend on m and the formulas should then be modified so that summing/averaging is not made over m or so that summing/averaging is limited to a set of m values for which coherency can be assumed.

### Methods for Estimating Doppler Spread Based on the Autocorrelation

In the Jake's model (i.e., for a homogenous channel in two dimensions), the Doppler spectrum is:

$$S ( f ) = \{ \begin{matrix}\frac{1}{π \cdot {f}_{max}} \cdot \frac{1}{\sqrt{1 - ( \frac{f}{{f}_{max}} )}} & ( \vert f \vert \leq {f}_{max} ) \\ 0 & ( \vert f \vert > {f}_{max} )\end{matrix}$$

and the autocorrelation which is the Fourier transform of the Doppler spectrum is equal to:

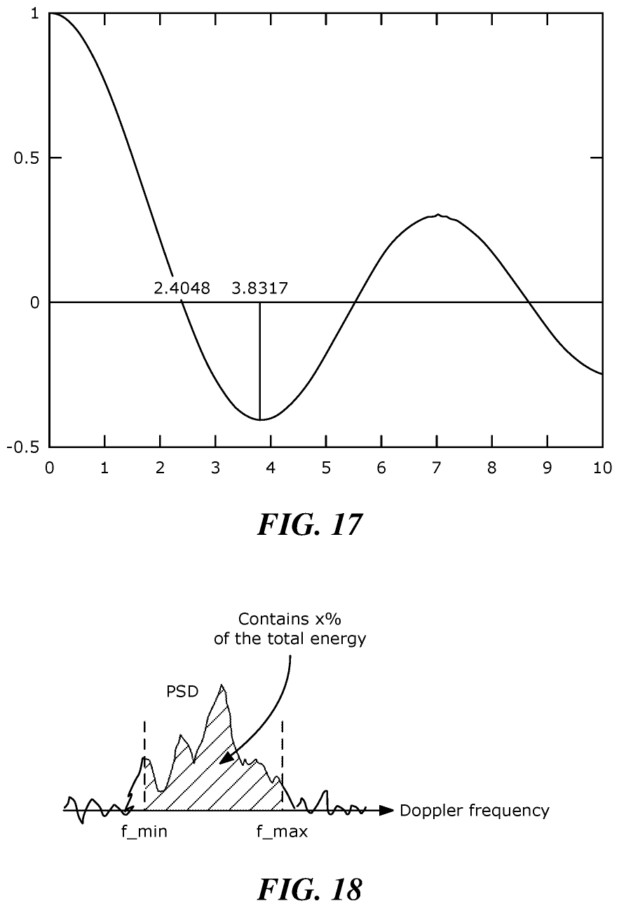

J₀(2π·τ·fₘₐₓ),

where J₀(·) is the zeroth order Bessel function of the first kind, which is shown in the example diagram of FIG. 17.

In some embodiments, the network node 16 or the WD 22 estimates the Doppler spread as:

$${f}_{max} = \frac{{J}_{0}^{- 1} ( \vert {ϕ}^{Δ r} ( t , τ ) \vert )}{2 π \cdot τ}$$

with the restriction that:

$$2 π \cdot {f}_{max} \cdot τ < 2.4 48.$$

In some embodiments, the network node 16 or the WD 22 estimates the Doppler spread as:

$${f}_{max} = \frac{{J}_{0}^{- 1} ( \vert {ϕ}^{Δ t} ( t , τ ) \vert \cdot sgn ( Re ( {ϕ}^{Δ t} ( t , τ ) ) ) )}{2 π \cdot τ}$$

with the restriction that:

$$2 π \cdot {f}_{max} \cdot τ < 3.8317 .$$

The accuracy of the estimates using the inverse of the Bessel function depends on how fast the correlation function changes with fₘₐₓ, i.e., on the size of:

$$\vert \frac{{dJ}_{0} ( 2 π \cdot τ \cdot {f}_{max} )}{{df}_{max}} \vert = \vert 2 π \cdot τ \cdot {J}_{0}^{′} ( 2 π \cdot τ \cdot {f}_{max} ) \vert$$

Since the derivative of the Bessel function is zero at zero, small delays result in low accuracy. On the other hand, large delays can give rise to ambiguities in the inversion of the Bessel function. Large delays can also result in an inversion point close to the Bessel function minimum at 3.8317 where the derivative is also zero, resulting in low accuracy. A delay making |2π·τ·J₀′(2π·τ·fₘₐₓ)| as large as possible while steering free of ambiguities may be used. This will depend on fₘₐₓ itself (or equivalently on the WD 22 velocity) in such a way that a smaller Doppler spread (or WD 22 velocity) requires a larger delay.

In some embodiments, the network node 16 or the WD 22 estimates autocorrelation for a number of delays τₖ with τₖ₊₁>τₖ and successively calculates:

$${f}_{max , k} = \frac{{J}_{0}^{- 1} ( \vert {ϕ}^{Δ t} ( t , {τ}_{k} ) \vert )}{2 π \cdot {τ}_{k}}$$

as long as

$${f}_{max , k} \cdot {τ}_{k + 1} < threshold$$

The last calculated f_{max,k} (i.e. f_{max,k} calculated for the highest k or equivalently for the largest τₖ) is used as estimate of fₘₐₓ.

In some embodiments, the network node 16 or the WD 22 estimates autocorrelation for a number of delays τₖ with τₖ₊₁>τₖ and successively calculates:

$${f}_{max , k} = \frac{{{J}_{0}}^{- 1} ( \vert {ϕ}^{Δ t} ( t , τ ) \vert \cdot sgn ( Re ( {ϕ}^{Δ t} ( t , τ ) ) ) )}{2 π \cdot τ}$$

as long as:

$${f}_{max , k} \cdot {τ}_{k + 1} < threshold$$

The last calculated f_{max,k} (i.e. f_{max,k} calculated for the highest k or equivalently for the largest τₖ) may be used as an estimate of fₘₐₓ.

In some embodiments, the network node 16 or the WD 22 estimates autocorrelation for a number of delays τₖ with τₖ₊₁>τₖ and successively calculates:

$${f}_{max , k} = \frac{{{J}_{0}}^{- 1} ( \vert {ϕ}^{Δ t} ( t , {τ}_{k} ) \vert )}{2 π \cdot {τ}_{k}}$$

as long as:

$$\vert {τ}_{k + 1} \cdot {{J}_{0}}^{′} ( 2 π \cdot {τ}_{k + 1} \cdot {f}_{max , k} ) \vert > \vert {τ}_{k} \cdot {{J}_{0}}^{′} ( 2 π \cdot {τ}_{k} \cdot {f}_{max , k} ) \vert$$

$$and$$

$${f}_{max , k} \cdot {τ}_{k + 1} < threshold .$$

The last calculated f_{max,k} (i.e. f_{max,k} calculated for the highest k or equivalently for the largest τₖ) may be used as an estimate of fₘₐₓ.

In some embodiments, the network node 16 or the WD 22 estimates autocorrelation for a number of delays τₖ with τₖ₊₁>τₖ and successively calculates:

$${f}_{max , k} = \frac{{{J}_{0}}^{- 1} ( \vert {ϕ}^{Δ t} ( t , τ ) \vert \cdot sgn ( Re ( {ϕ}^{Δ t} ( t , τ ) ) ) )}{2 π \cdot τ}$$

as long as:

$$\vert {τ}_{k + 1} \cdot {{J}_{0}}^{′} ( 2 π \cdot {τ}_{k + 1} \cdot {f}_{max , k} ) \vert > \vert {τ}_{k} \cdot {{J}_{0}}^{′} ( 2 π \cdot {τ}_{k} \cdot {f}_{max , k} ) \vert$$

$$and$$

$${f}_{max , k} \cdot {τ}_{k + 1} < threshold .$$

The last calculated f_{max,k} (i.e., f_{max,k} calculated for the highest k or equivalently for the largest τₖ) may be used as an estimate of fₘₐₓ. In some embodiments, the network node 16 or the WD 22 estimates the Doppler spread fₘₐₓ by fitting J₀(2π·τₖ·fₘₐₓ) to the estimated autocorrelation for a number of delays τₖ, e.g., as a least square fit of:

$${J}_{0} ( 2 π \cdot {τ}_{k} \cdot {f}_{max} ) = \vert {ϕ}^{Δ t} ( t , {τ}_{k} ) \vert \cdot sgn ( Re ( {ϕ}^{Δ t} ( t , {τ}_{k} ) ) ) )$$

or alternatively of:

$${J}_{0} ( 2 π \cdot {τ}_{k} \cdot {f}_{max} ) = \vert {ϕ}^{Δ t} ( t , {τ}_{k} ) \vert$$

In some embodiments, the network node 16 or the WD 22 translates the estimated Doppler spread to an estimate of the WD 22 velocity and reports the WD 22 velocity. In some embodiments, the WD 22 estimates the WD 22 velocity as:

$$v = \frac{c \cdot {f}_{max}}{2 \cdot {f}_{carrier}}$$

where f_{carrier} is the carrier frequency, c is the speed of light and f_{D} is the estimated Doppler spread.

In some embodiments, some other assumption on the form of the Doppler spectrum and the autocorrelation is used to estimate the Doppler spread based on the autocorrelation.

In some embodiments, the Doppler spectrum is assumed to be a square function:

$$S ( f ) = \{ \begin{matrix}\frac{1}{2 \cdot {f}_{m}} & ( \vert f \vert \leq {f}_{m} ) \\ 0 & ( \vert f \vert < {f}_{m} )\end{matrix} ,$$

with autocorrelation function:

$$ρ ( τ ) = sin c ( 2 π \cdot {f}_{m} \cdot τ ) = \frac{sin ( 2 π \cdot {f}_{m} \cdot τ )}{2 π \cdot {f}_{m} \cdot τ} .$$

and the sinc function is used estimate the Doppler spread fₘ either by using the inverse sinc (using a sinc restricted in domain to make the inverse unambiguous) or by fitting estimates of the autocorrelation at multiple delays τₖ to the sinc function form of the autocorrelation.

### Network Node Utilization of Reported Autocorrelation Based Measurement

In some embodiments, the network node 16 decides on mode switching based on the estimated autocorrelation at one or more delays.

In some embodiments, the network node 16 uses a threshold on the autocorrelation at a certain delay τ to decide on mode switching, e.g., as:

$$\vert {ϕ}^{Δ t} ( t , τ ) \vert > threshold \to switch to mode 2$$

$$\vert {ϕ}^{Δ t} ( t , τ ) \vert < threshold - hysteresis \to switch to mode 1$$

$$or as :$$

$$\vert {ϕ}^{Δ t} ( t , τ ) \vert \cdot sgn ( Re ( {ϕ}^{Δ t} ( t , τ ) ) ) > threshold \to switch to mode 2$$

$$\vert {ϕ}^{Δ t} ( t , τ ) \vert \cdot sgn ( Re ( {ϕ}^{Δ t} ( t , τ ) ) ) < threshold - hysteresis \to switch to mode 1$$

In some embodiments, the network node 16 uses the reported autocorrelation to estimate the Doppler spread (e.g., using one of the methods described herein) and use the estimated Doppler spread to decide on mode switching e.g. as:

doppler_spread>threshold→switch to mode 2

doppler_spread<threshold−hysteresis→switch to mode 1

In some embodiments, the Doppler spread as reported by the WD 22 is used by the network node 16 to decide on mode switching e.g. as:

doppler_spread>threshold→switch to mode 2

doppler_spread<threshold−hysteresis→switch to mode 1

### Signaling Embodiments

In some embodiments, the WD 22 can be configured to report the normalized autocorrelation of the channel at a number of delays τ. In some embodiments, the delays τ are preconfigured in the WD 22. In some embodiments, the delays τ are configurable by higher layer signaling, e.g., in a measurement configuration signaling message.

In some embodiments, the WD 22 reports a number of normalized autocorrelation values at different delays τ along with the different delays τ. In this case, the WD 22 is not explicitly configured as to which delays τ the WD 22 should feedback normalized autocorrelation. Instead, the WD 22 decides which delay values for which to compute normalized autocorrelation based on available TRS reference, and the WD 22 reports to the network node 16 the delay values and the computed normalized autocorrelation values.

In some embodiments, the network configures the WD 22 with N different delay values (i.e., N different τ values). The WD 22 will them compute normalized autocorrelation values for a subset of N′<N different delay values. This can be beneficial in cases where according to the available computational resources available to the WD 22, the WD 22 may only have computational resources to compute normalized autocorrelation values for only a subset of N′<N different delay values.

In some embodiments, the WD 22 is also configured with the number of samples the WD 22 may compute for each delay value. For instance, the network node 16 may configure the WD 22 to compute and report S different samples of normalized autocorrelation values for a given delay τ.

In another embodiment, a finite number of bits are used to quantize normalized autocorrelation values to be reported. For instance, each normalized autocorrelation value may be quantized by X bits. The step size or granularity of the quantized normalized autocorrelation may be predefined in 3GPP specifications. In some embodiments, the step size or granularity may be higher layer configured (e.g., RRC configured) to the WD 22 by the network node 16. In some embodiments, the number of bits X may also be higher layer configured (e.g., RRC configured) to the WD 22 by the network node 16.

In some embodiments, the delay values when reported by the WD 22 along with the normalized autocorrelation values are quantized. The step size or granularity of the delay values may be predefined in 3GPP specifications. In some embodiments, the step size or granularity may be higher layer configured (e.g., radio resource control (RRC) configured) to the WD 22 by the network node 16. In some embodiments, the number of bits for quantizing the delay values may also be higher layer configured (e.g., RRC configured) to the WD 22 by the network node 16.

In some embodiments, the preconfigured or configurable delays τ may be a subset of the following values:
Four OFDM symbols including CP;
10 OFDM symbols including CP;
14 OFDM symbols including CP, i.e. the length of a slot;
18 OFDM symbols including CP;
The period of the TRS bursts;
An integer multiple of the period of the TRS burst; and/or
An integer multiple of slots.

Note that the TRS burst periodicity is configurable to 10 ms, 20 ms, 40 ms or 80 ms in some embodiments. Delays of an integer multiple of the slot length can be achieved by triggering aperiodic TRS's at suitable time instances.

When reporting multiple estimated auto-correlations associated with different delays, in some embodiments, the auto-correlations are arranged in a report in increasing order of the associated delay values, e.g.:

{ϕ^{Δt}(t,τ₁),ϕ^{Δt}(t,τ₂), . . . ,ϕ^{Δt}(t,τₖ)} or {|ϕ^{Δt}(t,τ₁)|,|ϕ^{Δt}(t,τ₂)|, . . . |ϕ^{Δt}(t,τₖ)}

where τ₁<τ₂< . . . <τₖ.

For a given reference signal with N1 OFDM symbols configured for auto-correlation measurement, assume there are N2 unique delays τ₁<τ₂< . . . <τ_{N2} over which auto-correlation can be estimated. The WD 22 may be configured to report auto-correlations associated a subset of N3≤N2 delays. In some embodiments, the subset corresponds the first N3 delays τ₁<τ₂< . . . <τ_{N3}.

Each of the autocorrelations to be reported may be quantized. When only the amplitude, i.e., |ϕ^{Δt}(t, τ)|, is reported, it can be quantized linearly between 0 and 1 with a number of bits. In some embodiments, it may be quantized in dBs, i.e., 10 log 10(|ϕ^{Δt}(t, τ)|) is quantized with a step size of p dBs.

In some embodiments, the real part Re (ϕ^{Δt}(t, Tx)) and the imaginary part Im(ϕ^{Δt}(t, τₖ)) of the complex autocorrelation ϕ^{Δt}(t, τₖ) is reported to the network node 16.

In some embodiments, the absolute value |ϕΔ^{t}(t, τₖ)| and the complex phase arg(ϕ^{Δt}(t, τₖ)) of the complex autocorrelation function ϕ^{Δt}(t, τₖ) is reported to the network node 16. In some embodiments, the complex phase arg(ϕ^{Δt}(t, τₖ)) is signaled in degrees and is quantized in equidistant steps from 0 to 360 degrees.

The report can be periodic, aperiodic, or semi-persistent or triggered by an event.

In some embodiments, a report is triggered when a measurement (e.g. the autocorrelation at a certain delay or the Doppler spread) pass a threshold.

In some embodiments, the measurement configuration may include one or more of the following parameters:
What measures to report (e.g., Doppler spread, Autocorrelation, . . . );
The delay or delays for which the autocorrelation should be reported;
The maximum delay between TRS symbols that may be utilized for the measurement;
Type of reporting: periodic, aperiodic, semipersistent or event triggered;
The periodicity of the report;
The slot offset relative to the start of the system frame for periodic/semipersistent reporting;
A threshold value for event triggered reporting;
A hysteresis value for event triggered reporting;
ID for the TRS (CSI-RS for tracking) to use for the measurement;
one or more NZP CSI-RS resource sets with higher layer parameter trs-info set to a value of true; in some embodiments a mixture of both a periodic NZCP CSI-RS resource set and an aperiodic NZP CSI-RS resource set may be configured (i.e., when both periodic TRS and aperiodic TRS are to be used for calculating normalized autocorrelation or Doppler spread); and/or
The time period over which measurement filtering/averaging should be performed.

Note that one or more of the above parameters may be configured in the reporting configuration instead of the measurement configuration.

In some embodiments, the network node 16 configures a WD 22 to measure the autocorrelation at a certain delay and next triggers a pair of an aperiodic TRSs with a separation in time corresponding to the configured delay. The WD 22 may utilize the pair of aperiodic TRSs to perform the measurement of the autocorrelation and reports the autocorrelation and/or quantities derived from the autocorrelation to the network node 16.

### Doppler Shift or Frequency Offset Based Doppler Spread Estimation

The WD 22 may estimate the channel impulse response (CIR) and the corresponding power delay profile (PDP, i.e., the absolute square of the CIR) at a number of time instances at which a reference signal (i.e., the TRS) is available.

The WD 22 may identify a number of peaks in the PDP.

The WD 22 may estimate the frequency offset for each peak.

In some embodiments, the frequency offset is the frequency offset relative to the WD's receive frequency.

In some embodiments, the frequency offset is the frequency offset relative to the frequency of the strongest detected peak.

In some embodiments, the frequency offset of peak i is estimated as

$$Δ {f}_{i} = \frac{arg ( CIR ( {δ}_{i} , {t}_{2} ) \cdot \overline{CIR ( {δ}_{i} , {t}_{1} ) )}}{2 π \cdot ( {t}_{2} - {t}_{1} )}$$

where δ; is the delay of peak i in the CIR and t₁ and t₂ are the time of the two reference signal symbols used.

In some embodiments, the frequency offset of peak i relative to the frequency of peak 0 (e.g. the strongest peak) is estimated as

$$Δ {f}_{i} = \frac{arg ( CIR ( {δ}_{i} , {t}_{2} ) \cdot \overline{CIR ( {δ}_{i} , {t}_{1} ) )} \cdot \overline{CIR ( {δ}_{0} , {t}_{2} )} \cdot CIR ( {δ}_{0} , {t}_{1} )}{2 π \cdot ( {t}_{2} - {t}_{1} )}$$

In some embodiments, multiple pairs of reference signal symbols where each pair are separated with the same distance in time are used to improve the accuracy of the frequency offset estimates. Below is a more detailed example of how this can be done.

Let Xₗ[n], n=0 . . . N−1 be the received frequency domain reference signal samples after matched filtering. Index l denote the different OFDM symbols carrying the reference symbols used for the estimation. The starting point in time of the OFDM symbol l is given by tᵢ (to be precise, tₗ denotes the start of the non-CP part of the OFDM symbol). Index n denote reference signal sample index (assumed to be proportional to subcarrier index). It may be assumed that the reference signal used is on a regular comb, in some embodiments.

Let Pₘ(n), m=1 . . . M, n=1,2 be the l-indices of M symbol pairs to use for the estimation for a time offset τ=t_{P}_{ₘ}₍₂₎−t_{P}_{ₘ}₍₁₎. It may be assumed that all symbol pairs are separated by the same distance in time (small differences due to the existence of two different CP lengths can, however, typically be safely neglected and thus it's sufficient that the all symbol pairs are separated by the same inter symbol distance counted in number of OFDM symbols).

The CIR Yₗ[k] is calculated as the inverse DFT for each OFDM symbol l:

Yₗ[k]=ifft(Xₗ[n])

The PDP Pₗ[k] is calculated as:

$${P}_{l} [ k ] = {\vert {Y}_{l} [ k ] \vert}^{2}$$

A number of peaks i at delays kᵢ are identified in the PDP. Here, a noise threshold may be used to avoid detection of false noise peaks. Methods to avoid detecting side peaks (sometimes referred to as side lobes) as real peaks may also be used, such as thresholds dependent on the relative delay between already detected peaks and candidate peaks.

In some embodiments, the frequency offset for a peak i at delay kᵢ is calculated as:

$$Δ {f}_{i} = \frac{{\sum }_{m = 1}^{M} {Y}_{{P}_{m} ( 2 )} [ {k}_{i} ] \cdot {Y}_{{P}_{m} ( 1 )}^{*} [ {k}_{i} ]}{2 π \cdot τ}$$

In some embodiments, the frequency offset of peak i at delay kᵢ relative to the frequency of peak 0 (e.g. the strongest peak) is estimated as:

$$Δ {f}_{i} = \frac{{\sum }_{m = 1}^{M} {Y}_{{P}_{m} ( 2 )} [ {k}_{i} ] \cdot {Y}_{{P}_{m} ( 1 )}^{*} [ {k}_{i} ] \cdot {Y}_{{P}_{m} ( 1 )} [ {k}_{0} ] \cdot {Y}_{{P}_{m} ( 2 )}^{*} [ {k}_{0} ]}{2 π \cdot τ}$$

If the delay τ is large, e.g., if the estimation is done across two different TRS bursts τ being equal to the TRS burst period or to a multiple of the TRS burst period, then the WD 22 may have adjusted the OFDM window between the reception of the first and second TRS symbol used in the measurement. This results in a cyclic shift Δk of the channel impulse response in delay. In addition, phase coherency may be lost resulting in an overall phase difference between measurements performed at the two occasions in time. Methods are presented to estimate the cyclic shift Δk of the channel impulse response are given. Based on estimated cyclic shift Δk, the formula above for the frequency offset for a peak i at delay kᵢ can be adjusted as:

$$Δ {f}_{i} = \frac{{\sum }_{m = 1}^{M} {Y}_{{P}_{m} ( 2 )} [ ( {k}_{i} + Δ k ) mod N ] \cdot {Y}_{{P}_{m} ( 1 )}^{*} [ {k}_{i} ]}{2 π \cdot τ}$$

Similarly, the equation for the frequency offset of peak i at delay kᵢ relative to the frequency of peak 0 (e.g. the strongest peak) can be adjusted as:

$$Δ {f}_{i} = \frac{\begin{matrix}{\sum }_{m = 1}^{M} {Y}_{{P}_{m} ( 2 )} [ ( {k}_{i} + Δ k ) mod N ] \cdot {Y}_{{P}_{m} ( 1 )}^{*} [ {k}_{i} ] \cdot \\ {Y}_{{P}_{m} ( 1 )} [ {k}_{0} ] \cdot {Y}_{{P}_{m} ( 2 )}^{*} [ ( {k}_{0} + Δ k ) mod N ]\end{matrix}}{2 π \cdot τ}$$

To compensate for phase coherency, the frequency offset for a peak i at delay kᵢ is estimated as:

$$Δ {f}_{i} = \frac{{\sum }_{m = 1}^{M} {Y}_{{P}_{m} ( 2 )} [ ( {k}_{i} + Δ k ) mod N ] \cdot {e}^{- i φ} \cdot {Y}_{{P}_{m} ( 1 )}^{*} [ {k}_{i} ]}{2 π \cdot τ}$$

where φ is an estimate of the phase offset. In some embodiments, φ is an estimate of the phase difference of the channel impulse response at the delay k′ of the strongest peak, estimated e.g. as:

$$φ = arg ( {\sum }_{m = 1}^{M} {Y}_{{P}_{m} ( 2 )} [ ( {k}^{′} + Δ k ) mod N ] \cdot {Y}_{{P}_{m} ( 1 )}^{*} [ {k}^{′} ] )$$

Note that the frequency offset relative to a peak 0:

$$Δ {f}_{i} = \frac{{\sum }_{m = 1}^{M} {Y}_{{P}_{m} ( 2 )} [ {k}_{i} ] \cdot {Y}_{{P}_{m} ( 1 )}^{*} [ {k}_{i} ] \cdot {Y}_{{P}_{m} ( 1 )} [ {k}_{0} ] \cdot {Y}_{{P}_{m} ( 2 )}^{*} [ {k}_{0} ]}{2 π \cdot τ}$$

is by construction independent of such a phase offset.

In some embodiments, the Doppler spread is estimated as:

$${f}_{D} = {max}_{i} Δ {f}_{i} - {min}_{i} Δ {f}_{i}$$

The accuracy of the different frequency offsets Δfᵢ is typically different due to varying strengths of the different peaks, for example. This is not taken into account in the measure above, which may lead to the accuracy of the Doppler spread estimate not improving with SINR as might be expected. As SINR increases, additional peaks can be detected above noise and interference. The new peaks have the potential to reduce the bias of the estimate, but since they are close to the noise and interference level the accuracy of the frequency offset estimates is low, which impacts the accuracy of the Doppler spread estimate. This can be solved by a number of alternative methods described below.

In some embodiments, the Doppler spread is estimated as:

$${f}_{D} = {max}_{\{ i \vert p ( i ) > η \cdot {p}_{max} \}} Δ {f}_{i} - {min}_{\{ i \vert p ( i ) > η \cdot {p}_{max} \}} Δ {f}_{i}$$

where pₘₐₓ is the power of the strongest detected peak and η is a threshold parameter between 0 and 1 I.e., only peaks with a power above a threshold relative to the strongest peaks are this may included. Viewed as an estimate of the maximum Doppler spread

$$2 \frac{v}{c} \cdot {f}_{carrier} ,$$

this may introduce a stronger bias. Seen as an alternative measure of Doppler spread, this is however not the case. In some embodiments, the relative threshold is preconfigured for the WD 22. In some embodiments, the relative threshold η is signaled to the WD 22. In some embodiments, the relative threshold is signaled in logarithmic scale to the WD 22 as 10·log 10 (η) dB.

In some embodiments, the Doppler spread is estimated as:

$${f}_{D} = {max}_{i} ( Δ {f}_{i} - κ \cdot {σ}_{i} ) - {min}_{i} ( Δ {f}_{i} + κ \cdot {σ}_{i} )$$

where φᵢ is an estimate of the variance of the frequency shift estimate Δfᵢ and κ is a positive constant.

In some embodiments, the Doppler spread is estimated as:

$${f}_{D} = B - A$$

where A and B are given by solving for A and B in:

$$P ( Δ {f}_{i}^{a} < B ∀ i \vert Δ {f}_{i}^{est} = Δ {f}_{i} ∀ i ) = p$$

$$P ( Δ {f}_{i}^{a} > A ∀ i \vert Δ {f}_{i}^{est} = Δ {f}_{i} ∀ i ) = p$$

for some parameter value p between 0 and 1, where Δfᵢ^{a} is the frequency offset of peak i, while Δfᵢ^{est} is the estimated frequency offset of peak i.

Note that P(Δfᵢ^{a}<B∀i|Δfᵢ^{est}=Δfᵢ∀i) is the probability that B is an overestimate of the maximum frequency offsets among the identified peaks and that 1−P(Δfᵢ^{a}<B∀i|Δᵢ^{est}=Δfᵢ∀i) is the probability that B is an underestimate of the maximum Doppler shift among the identified peaks. Similarly P(Δfᵢ^{a}>A∀i|Δfᵢ^{est}=Δfᵢ∀i) is the probability that A is an underestimate of the minimum frequency offset among the identified peaks and that 1−P(Δfᵢ^{a}>A∀i|Δfᵢ^{est}=Δfᵢ∀i) is the probability that A is an overestimate of the maximum Doppler shift among the identified peaks.

In some embodiments, probabilities are approximated as:

$$P ( Δ {f}_{i}^{a} < B ∀ i \vert Δ {f}_{i}^{est} = Δ {f}_{i} ∀ i ) = {\prod }_{i} P ( Δ {f}_{i}^{a} < B \vert Δ {f}_{i}^{est} = Δ {f}_{i} ) = {\prod }_{i} ( \frac{1}{2} + \frac{1}{2} erf ( \frac{B - Δ {f}_{i}}{\sqrt{2} \cdot {σ}_{i}} ) )$$

$$P ( Δ {f}_{i}^{a} > A ∀ i \vert Δ {f}_{i}^{est} = Δ {f}_{i} ∀ i ) = {\prod }_{i} P ( Δ {f}_{i}^{a} > B \vert Δ {f}_{i}^{est} = Δ {f}_{i} ) = {\prod }_{i} ( \frac{1}{2} + \frac{1}{2} erf ( \frac{Δ {f}_{i} - A}{\sqrt{2} \cdot {σ}_{i}} ) )$$

and solve for A and B in:

$${\prod }_{i} ( \frac{1}{2} + \frac{1}{2} erf ( \frac{B - Δ {f}_{i}}{\sqrt{2} \cdot {σ}_{i}} ) ) = p$$

$${\prod }_{i} ( \frac{1}{2} + \frac{1}{2} erf ( \frac{Δ {f}_{i} - A}{\sqrt{2} \cdot {σ}_{i}} ) ) = p$$

The WD 22 may report the Doppler spread f_{D} as estimated by some of the above methods to the network node 16.

In some embodiments, the WD 22 translates the estimated Doppler spread to an estimate of the WD 22 velocity and reports the WD 22 velocity. In some embodiments, the WD 22 estimates the WD 22 velocity as:

$$v = \frac{c \cdot {f}_{D}}{2 \cdot {f}_{carrier}}$$

where f_{carrier} is the carrier frequency, c is the speed of light and f_{D} is the estimated Doppler spread.

In some embodiments, the WD 22 estimates the nth moment around the weighted mean of the frequency offsets of the identified peaks as:

$${m}_{n} = \frac{{\sum }_{i} {w}_{i} \cdot {( Δ {f}_{i} - Δ {f}_{mean} )}^{n}}{{\sum }_{i} {w}_{i}}$$

where the weighted mean of the frequency shifts is calculated as

$$Δ {f}_{mean} = \frac{{\sum }_{i} {w}_{i} \cdot Δ {f}_{i}}{{\sum }_{i} {w}_{i}}$$

In some embodiments, the weights used are

$${w}_{i} = \frac{1}{{σ}_{i}} ,$$

where σᵢ is an estimate of the variance of the frequency shift estimate Δfᵢ.

In some embodiments, the weights used are wᵢ=pᵢ, where pᵢ is an estimate of the power of peak i.

The WD 22 estimates one or more of the nth moments and reports them to the network node 16.

### Signaling Embodiments for Doppler Shift or Frequency Offset Based Methods

In some embodiments, the WD 22 may report the identified peaks including for each peak i one or more of the following estimates:
The frequency offset Δfᵢ;
The peak power pᵢ;
The peak SINR,

$$S I N {R}_{i} = \frac{{p}_{i}}{{( {σ}_{IN} )}^{2}} ;$$

The estimated variance φᵢ of the frequency offset estimate Δfᵢ; and/or
The peak delay kᵢ.

In some embodiments, the WD 22 estimates the Doppler spread based on the frequency offsets and reports the Doppler spread to the network node 16.

In some embodiments, the WD 22 estimates one or more of the nth moments of the frequency offsets and reports them to the network node 16.

In some embodiments, the Doppler spread is estimated such that X % of the total received signal energy is contained between the estimated minimum and maximum Doppler frequencies, where X % can be 90% for example. An example is illustrated in the diagram of FIG. 18 where the estimated Doppler spread is f_max−f_min.

In some embodiments, a report is triggered when a measure (e.g., the Doppler spread) passes a threshold.

In some embodiments, the measurement configuration may include one or more of the following parameters:
What measures to report (e.g., Doppler spread, Frequency offsets per peak, . . . );
The maximum delay between TRS symbols that may be utilized for the measurement;
Type of reporting: periodic, aperiodic, semipersistent or event triggered;
The periodicity of the report;
The slot offset relative to the start of the system frame for periodic/semipersistent reporting;
A threshold value for event triggered reporting;
A hysteresis value for event triggered reporting;
ID for the TRS (CSI-RS for tracking) to use for the measurement; and/or
The time period over which measurement filtering/averaging should be performed.

Note that one or more of the above parameters may be configured in the reporting configuration instead of the measurement configuration.

### Matching of the Channel Impulse Response at Different Time Instances

The WD 22 may sometimes adjust the OFDM window based on the form of the estimated channel impulse response, for example. Such an adjustment results in a cyclic shift of the channel impulse response in delay. This should not happen within a slot and it should not happen within a TRS burst. It may, however, very well happen between TRS bursts. Several methods described here, rely on a condition that the channel impulse response for two different times is combined at the same delay. It may be necessary to adjust for such OFDM window adjustments, i.e., to identify the cyclic shift Δk in delay, in some embodiments.

In some embodiments, the WD 22 estimates the OFDM window offset Δk based on an internal clock.

In some embodiments, the matching of the channel impulse responses is performed based on a machine learning algorithm. In some embodiments, the machine learning (ML) algorithm is trained with real or synthetic channel data for pairs of time occasions at a certain separation in time, where one of the two channel impulse responses is artificially rotated cyclically a random number of steps and the ML algorithm is trained to identify the number of steps one of the two channel impulse responses has been cyclically rotated.

In some embodiments, the OFDM window offset Δk samples, is estimated by finding the offset Δk which gives the best match between the impulse response at the two time occasion. In some embodiments, the best match is defined as the match that gives the highest number of matching peaks.

In some embodiments, the OFDM window offset Δk samples is estimated by finding the offset Δk which minimizes a cost function. In some embodiments, the cost function is a sum of terms, with one term for each combination of a peak identified in a first symbol and a peak identified in a second symbol and each term is a function of the circular distance between the two peaks after a circular shift Δk being performed on the second peak. In some embodiments, the terms are weighted based on the peak powers. In some embodiments, the terms are weighted based on the peak SINR.

Some embodiments include letting Xₗ[n], n=0 . . . N−1 be the received frequency domain reference signal samples after matched filtering. Let index l denote the different OFDM symbols carrying the reference symbols used for the estimation. The starting point in time of the OFDM symbol l is given by ty (to be precise ty denotes the start of the non-CP part of the OFDM symbol). Index n denotes a reference signal sample index (assumed to be proportional to subcarrier index). It is assumed that the reference signal used is on a regular comb.

Let Pₘ(n), m=1 . . . M, n=1,2 be the l-indices of M symbol pairs to use for the estimation for a time offset τ=t_{P}_{ₘ}₍₂₎−T_{P}_{ₘ}₍₁₎. Assume that all symbol pairs are separated by the same distance in time (small differences due to the existence of two different CP lengths can, however, typically be safely neglected and thus, it is sufficient that all symbol pairs are separated by the same inter symbol distance counted in number of OFDM symbols).

The CIR Yₗ[k] may be calculated as the inverse DFT for each OFDM symbol l:

Yₗ[k]=ifft(Xₗ[n]).

The PDP Pₗ[k] may be calculated as:

$${P}_{l} [ k ] = {\vert {Y}_{l} [ k ] \vert}^{2} .$$

A number of peaks j at delays k_{P}_{ₘ}_{(n),j} are identified in each PDB, i.e., for each symbol Pₘ(n), m=1 . . . M, n=1,2. Here, a noise threshold may be used to avoid detection of false noise peaks. Methods to avoid detecting side peaks (sometimes referred to as side lobes) as real peaks may also be used, such as thresholds dependent on the relative delay between already detected peaks and candidate peaks.

In some embodiments, the OFDM window offset Δk samples may be estimated by finding the offset Δk which minimizes a cost function. In some embodiments, the cost function is a sum of terms, with one term for each combination of a peak identified in a first symbol Pₘ(1) and a peak identified in a second symbol P_{m′}(2) and each term is a function of the circular distance between the two peaks after a circular shift Δk being performed on the second peak, e.g. as:

$$f ( Δ k ) = {\sum }_{j} {\sum }_{l} {\sum }_{m} {\sum }_{{m}^{′}} g ( cdist ( {k}_{{P}_{m} ( 1 ) , j} , ( {k}_{{P}_{{m}^{′}} ( 2 ) , l} + Δ k ) mod N ) )$$

where k_{s,j} is the delay in units of time samples of the jth identified peak in OFDM symbol s, and the circular distance is defined as:

$$cdist ( k , {k}^{′} ) ≡ min ( \vert k - {k}^{′} \vert , N - \vert k - {k}^{′} \vert )$$

In some embodiments, the term wise cost function g(k) is a square function

$$g ( k ) = \{ \begin{matrix}- 1 & k < a \\ 0 & k \geq a\end{matrix}$$

for some parameter value a, e.g., some value a with size of the same order of magnitude as the inverse of the Nyquist frequency in units of time samples.

In some embodiments, the function g is a gaussian:

$$g ( k ) = - {e}^{- {( \frac{k}{a} )}^{2}}$$

In some embodiments, the term in the cost function is weighted, e.g. with weights depending on the power of the peaks or the peak SINR, e.g. as:

$$f ( Δ k ) = {\sum }_{j} {\sum }_{l} {\sum }_{m} {\sum }_{{m}^{′}} w ( {P}_{{P}_{m} ( 1 )} [ {k}_{{P}_{m} ( 1 ) , l} ] , {P}_{{P}_{{m}^{′}} ( 2 )} [ {k}_{{P}_{{m}^{′}} ( 2 ) , l} ] ) \cdot g ( cdist ( {k}_{{P}_{m} ( 1 ) , j} , ( {k}_{{P}_{{m}^{′}} ( 2 ) , l} + Δ k ) mod N ) )$$

In some embodiments:

$$w ( {p}_{1} , {p}_{2} ) = \sqrt{{p}_{1} \cdot {p}_{2}}$$

In some embodiments, the term in the cost function is weighted with weights depending on the peak SINR, e.g. as:

$$f ( Δ k ) = {\sum }_{j} {\sum }_{l} {\sum }_{m} {\sum }_{{m}^{′}} w ( \frac{{P}_{{P}_{m} ( 1 )} [ {k}_{{P}_{m} ( 1 ) , l} ]}{{( {σ}_{{P}_{m} ( 1 )} )}^{2}} , \frac{{P}_{{P}_{{m}^{′}} ( 2 )} [ {k}_{{P}_{{m}^{′}} ( 2 ) , l} ]}{{( {σ}_{{P}_{{m}^{′}} ( 2 )} )}^{2}} ) \cdot g ( cdist ( {k}_{{P}_{m} ( 1 ) , j} , ( {k}_{{P}_{{m}^{′}} ( 2 ) , l} + Δ k ) mod N ) )$$

where σₛ is the estimated variance of noise and interference in symbol s.

In some embodiments:

$$w ( S I N {R}_{1} , S I N {R}_{2} ) = \sqrt{S I N {R}_{1} \cdot S I N {R}_{2}}$$

Note that in the formulas above it's assumed that there is no OFDM window change between OFDM symbols Pₘ(1), m=1 . . . M. Similarly it is assumed that there is no OFDM window change between OFDM symbols Pₘ(2), m=1 . . . M. An OFDM window change is only assumed to occur between OFDM symbols Pₘ(1) and P_{m′}(2), in this example This may typically be the case when OFDM symbols Pₘ(1), m=1 . . . M are all within one and the same TRS burst, while P_{m′}(2), m=1 . . . M′ are all within another TRS burst. Generally, Δk can be allowed to depend on m and the formulas should then be modified so that summing/averaging is not made over m and m′ or so that summing/averaging is limited to a set of m and m′values for which coherency may be assumed.

### Mode Switching

In some embodiments, the estimates of autocorrelation, Doppler spread or WD 22 velocity may be used by the network node 16 to switch mode, e.g., using thresholds of the following type:

estimate>threshold→switch to mode 2

estimate<threshold−hysteresis→switch to mode 1

The pair of modes switching is performed between may be, for example:
SRS based reciprocity mode vs. CSI feedback based mode;
No additional DMRS symbols vs. One additional DMRS symbol; and/or
Two additional DMRS symbols vs. Three additional DMRS symbols.

In some embodiments, the network node 16 takes the decision on mode switching based on a number of parameters, including one or more of the following parameters:
Estimated autocorrelation at one or more delays;
Estimated Doppler spread; and/or
Estimated WD 22 velocity.

### Higher Layer Configuration

Some embodiments use higher layer signaling to enable TRS-based Doppler estimation.

### CSI-MeasConfig

A new csi-TRS resource list and/or csi-TRS report list may be added to CSI-MeasConfig, csi-TRS-ResourceConfigToAddModList, csi-TRS-ResourceConfigToReleaseList. csi-TRS-ReportConfigToAddModList, csi-TRS-ReportConfigToReleaseList.

```
CSI-MeasConfig-r18 ::= SEQUENCE {
...
  csi-TRS-ResourceConfigToAddModList SEQUENCE (SIZE
    (1..maxNrofCSI-TRS-ResourceConfigurations)) OF CSI-TRS-
    ResourceConfig
      OPTIONAL, -- Need
    N
csi-TRS-ResourceConfigToReleaseList SEQUENCE (SIZE (1..maxNrofCSI-
    TRS-ResourceConfigurations)) OF CSI-TRS-ResourceConfigId
    OPTIONAL, -- Need N
  csi-TRS-ReportConfigToAddModList SEQUENCE (SIZE (1..maxNrofCSI-
    TRS-ReportConfigurations)) OF CSI-ReportConfig-r18 OPTIONAL, -
    - Need N
  csi-TRS-ReportConfigToReleaseList SEQUENCE (SIZE (1..maxNrofCSI-
    TRS-ReportConfigurations)) OF CSI-ReportConfigId
        OPTIONAL,
    -- Need N
...
}
```

The pool of CSI-TRS-ResourceConfig can be referred to from CSI-ResourceConfig or from medium access control (MAC) control elements (CEs).

In some embodiments, in CSI-ReportConfig-r18, csi-TRS-ResourceForDoppler is added.

| | |
|---|---|
| CSI-ResourceConfigId ::= | SEQUENCE { |
| reportConfigId | CSI-ReportConfigId, |
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| csi-TRS-ResouceForDoppler | CSI-ResourceConfigId |

OPTIONAL,
...

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

```
        OPTIONAL -- Need S
    },
```

| | |
|---|---|
| cri-RI-CQI | NULL, |
| cri-RSRP | NULL, |
| ssb-Index-RSRP | NULL, |
| cri-RI-LI-PMI-CQI | NULL, |
| trs-Doppler | NULL, |

...
csi-TRS-DopplerReportConfiguration SEQUENCE {

| | |
|---|---|
| csi-TRS-DopperReportMod | ENUMBERATED {AutoCorrelation, |

DopplerShiftAndFrequencyOffset}

| | |
|---|---|
| numberofTRSBurst | ENUMERATED {n1, n2, n4} |
| AutoCorrQuantization | ENUMERATED {q1,q2,q3} |
| triggerQantityAndThreshold | ENUMERATED {opt1, opt2} |

}

Example configurations for csi-TRS-Doppler are herein. The configurations may be associated with the measurement methods described herein.

Within the CSI-ReportConfig-r18, a new quantity “trs-Doppler” may be added.

csi-TRS-DopplerReportMod may be provided to configure the measurement and report type for Doppler information.

The numberofTRSBurst may be provided to indicate to WD 22 the time related to the time delay τ.

AutoCorrQuantization may be provided to indicate to WD 22 the quantization for Autocorrelation reporting.

triggerQuantityAndThreshold may be provided to the WD 22 if event triggered Doppler report is configured. In one example, one bit per CSI-TRS measurement/report is reserved in the CSI report and the WD 22 reports 1 using the pre-reserved bit if the event is met. A typical event can be number of times a function of calculated autocorrelation value fluctuates above and below a threshold a certain number of times.

Use of Other Signals than the TRS and Measurements Performed by Network Node 16

The methods described here have been based on the use of the TRS signal (CSI-RS for tracking). They may, however, be used based on other reference signals such as, e.g., other types of CSI-RS, uplink and downlink DMRS, and uplink SRS.

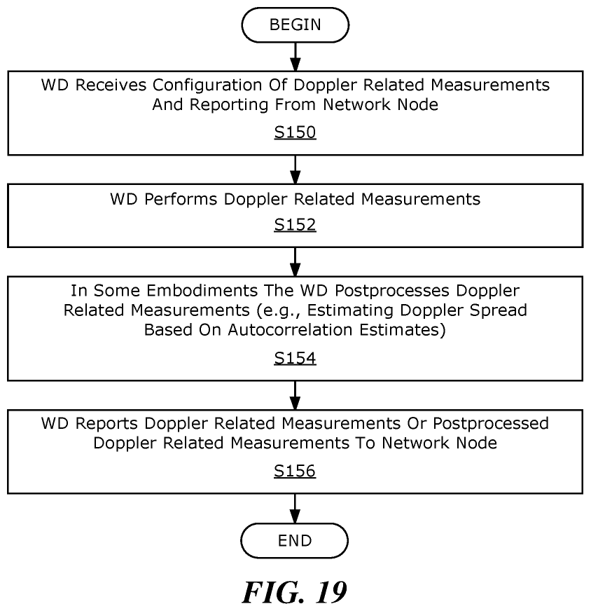

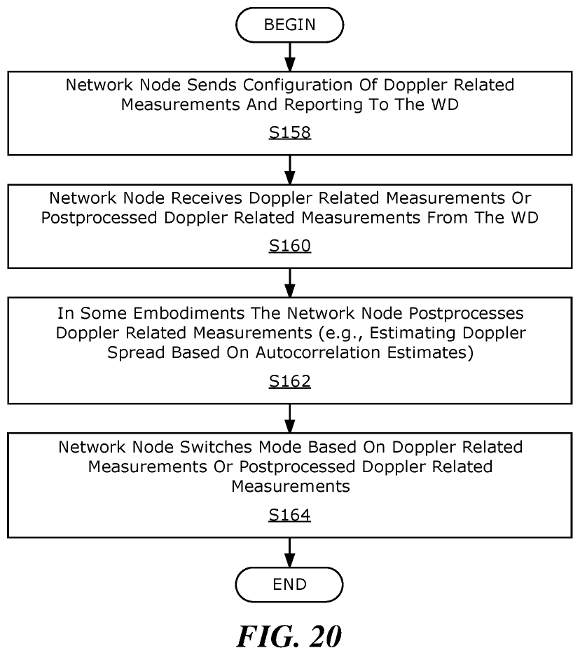

FIGS. 19 and 20 are flowcharts of example processes in a WD 22 (FIG. 19) and a network node 16 (FIG. 20), according to principles disclosed herein.

When uplink signals are used, the network node 16 may perform the measurements described herein, e.g., measurements of the autocorrelation, frequency offsets per identified peak, Doppler spread, etc. When applicable, the network node 16 may also perform peak detection and matching of the channel impulse response. When the network node 16 performs the measurements, no signaling is needed to report the measurements from the WD 22 to the network node 16. The network node 16 may use the measurements directly, e.g., to decide on mode switching.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device, WD, configured to communicate with a network node, the method comprising:
determining an autocorrelation estimate for a channel between the WD and the network node for each time delay of M time delays, M being an integer;
quantizing, for each time delay of the M time delays, an amplitude and phase of the autocorrelation estimate determined for the corresponding time delay; and
reporting to the network node the quantized amplitude and phase of each of the autocorrelation estimates for the M time delays.

2. The method of claim 1, wherein the M time delays are selected from a group of N configured time delays, N being an integer greater than or equal to M.

3. (canceled)

4. The method of claim 2, further comprising receiving from the network node an indication of:
the N configured time delays; or
the M time delays.

5.-7. (canceled)

8. The method of claim 1, further comprising estimating the channel at multiple time instances based at least in part on at least one reference signal, wherein the multiple time instances are associated with the M time delays.

9. The method of claim 1, wherein the autocorrelation estimate for the channel for a time delay is determined based at least in part on channel estimates at least at two time instances of the multiple time instances, wherein the two time instances are separated by a time duration equal to the time delay.

10. The method of claim 9, wherein each of the at least one reference signal is a tracking reference signal, TRS.

11. (canceled)

12. (canceled)

13. The method of claim 9, further comprising determining the autocorrelation estimate for each of the M time delays based at least in part on channel estimates at the multiple time instances.

14. (canceled)

15. (canceled)

16. The method of claim 1, wherein the autocorrelation estimates are determined for each of the M time delays based at least in part on at least one of a channel state information reference signal, CSI-RS, and a demodulation reference signal, DMRS, separated in time.

17. The method of claim 1, wherein reporting to the network node the indication of the autocorrelation estimates is one of semi-persistent and aperiodic.

18. The method of claim 1, further comprising receiving a configuration of at least one reference signal and a channel state information, CSI, report for reporting the autocorrelation estimates for the M time delays based on the at least one reference signal.

19. A wireless device, WD, (22) having processing circuitry and a radio interface (82) that configure the WD to:
determine an autocorrelation estimate for a channel between the WD and the network node for each time delay of M time delays, M being an integer;
quantize, for each time delay of the M time delays, an amplitude and phase of the autocorrelation estimate determined for the corresponding time delay; and
report to the network node the quantized amplitude and phase of each of the autocorrelation estimates for the M time delays.

20. A method in a network node configured to communicate with a wireless device, WD, the method comprising:
configuring the WD with an autocorrelation report configuration, the autocorrelation report configuration including an indication of M time delays, M being an integer;
configure the WD to quantize, for each of time delay of the M time delays, an amplitude and phase of an autocorrelation estimate for a channel between the WD and the network node for the corresponding time delay; and
receiving from the WD a quantized amplitude and phase of an autocorrelation estimate for each time delay of the M time delays.

21.-26. (canceled)

27. The wireless device of claim 19, wherein the M time delays are selected from a group of N configured time delays, N being an integer greater than or equal to M.

28. The wireless device of claim 27, wherein the processing circuitry and the radio interface further configure the WD to receive from the network node an indication of:
the N configured time delays; or
the M time delays.

29. The wireless device of claim 19, wherein the processing circuitry and the radio interface further configure the WD to estimate the channel at multiple time instances based at least in part on at least one reference signal, wherein the multiple time instances are associated with the M time delays.

30. The wireless device of claim 19, wherein the autocorrelation estimate for the channel for a time delay is determined based at least in part on channel estimates at least at two time instances of the multiple time instances, wherein the two time instances are separated by a time duration equal to the time delay.

31. The wireless device of claim 19, wherein the processing circuitry and the radio interface further configure the WD to determine the autocorrelation estimate for each of the M time delays based at least in part on channel estimates at the multiple time instances.

32. The wireless device of claim 19, wherein the autocorrelation estimates are determined for each of the M time delays based at least in part on at least one of a channel state information reference signal, CSI-RS, and a demodulation reference signal, DMRS, separated in time.

33. The wireless device of claim 19, wherein reporting to the network node the indication of the autocorrelation estimates is one of semi-persistent and aperiodic.

34. The wireless device of claim 19, wherein the processing circuitry and the radio interface further configure the WD to receive a configuration of at least one reference signal and a channel state information, CSI, report for reporting the autocorrelation estimates for the M time delays based on the at least one reference signal.
